(19) United States
(12) Patent Application Publication
(10) Pub. No.: US 2004/0081350 A1
(43) Pub. Date: Apr. 29, 2004

(54) Pattern inspection apparatus and method

(76) Inventors: Tadashi Kitamura, Kawasaki (JP); Kazufumi Kubota, Kawasaki (JP); Masahiro Yamamoto, Kawasaki (JP)

Correspondence Address: WENDEROTH, LIND & PONACK, L.L.P., 2033 K STREET N. W., SUITE 800, WASHINGTON, DC, 20006-1021, US

(21) Appl. No.: 10/689,021

(22) Filed: Oct. 21, 2003

Related U.S. Application Data
(63) Continuation-in-part of application No. 09/648,372, filed on Aug. 25, 2000.

(30) Foreign Application Priority Data
Oct. 22, 2002 (JP) 2002-307406
Aug. 26, 1999 (JP) 11-239586
Mar. 21, 2000 (JP) 2000-078847

(51) Int. Cl. G06K 9/00

(52) U.S. Cl. 382/149

(57) ABSTRACT

A pattern inspection apparatus inspects fine patterns such as semiconductors (LSI), liquid crystal panels, and masks (reticles) for those. The pattern inspection apparatus includes a storage device for storing said reference pattern, an image generator for scanning the pattern to-be-inspected with a charged particle beam to produce an image of the pattern to-be-inspected, an input device for inputting the image of the pattern to-be-inspected, an inspection device for inspecting the pattern to-be-inspected by comparing an edge of the inputted image of the pattern to-be-inspected and an edge of the stored reference pattern with each other, and an output device for outputting a result of the inspection of the pattern to-be-inspected.

This is a continuation-in-part application of U.S. application Ser. No. 09/648,372 filed Aug. 25, 2000.

### BACKGROUND OF THE INVENTION

1. Field of the Invention

The present invention relates to a pattern inspection apparatus and method, and more particularly to a pattern inspection apparatus and method for inspecting fine patterns, such as semiconductors (LSI), liquid crystal panels, and masks (reticles) for the semiconductors or the liquid crystal panels, which are formed according to design data.

2. Description of the Related Art

For the pattern inspection of wafers in the manufacturing process of semiconductor integrated circuits or the pattern inspection of masks for pattern formation thereof, an optical pattern inspection apparatus which uses a method called die-to-die comparison is used. In this inspection method, a defect is found by comparing an image obtained from a die to-be-inspected (die that is an object of inspection) and an image obtained from the equivalent position of a die adjacent to the die to-be-inspected.

On the other hand, for the inspection of a mask (a reticle) where no adjacent dies exist, a method called die-to-database comparison is adopted. That is, a method in which CAD data is converted into an image format and the image format is used instead of the adjacent dies, and the same inspection as described above is performed, is used. The technology concerned is disclosed, for example, in U.S. Pat. No. 5,563,702, “Automated photomask inspection apparatus and method.” However, in this method, because a rounded part of a corner of an actual pattern formed on the wafer is likely to be recognized as a defect, this problem is circumvented by a method of conducting pretreatment to give a rounding to the image obtained from CAD data as a countermeasure. In such a circumstance where the corners are rounded, when the die to database comparison inspection is performed, it is likely that pattern deformation which should not be judged as a defective corner is recognized as a defect, and this may happen frequently even if the above-described pretreatment is conducted. Conversely, if a setting that ignores the pattern deformation of the corner is adopted, there arises a dilemma that a minute defect existing in some places other than the corners cannot be recognized.

Presently, for masks, inspection on the basis of the die-to-database comparison method has been put into practical use because the mask should be exactly in conformity with the CAD data. However, the pattern transferred on the wafer is allowed to be deformed to the extent that electrical characteristic and the like are secured, and in practice, the pattern deformation occurs to a considerable extent because of difference of an exposure condition or the like.

Moreover, the pattern inspection on the basis of the aforesaid die-to-die comparison method cannot detect a defect called a systematic defect that occurs in common over all the dies on the wafer caused by the mask failure. That is, the same defects occur in the die to-be-inspected and in the adjacent dies that are to be compared with the die to be-inspected, and hence the comparison between the both dies cannot lead to the detection of the defect of the die which is being inspected.

Therefore, although it has not been put into practical use because of calculation cost or the like, there has been proposed matching inspection between the CAD data and the wafer image. This matching inspection is disclosed in, for example, a literature: “Automatic failure part tracing method for a logic LSI using an electron beam tester,” NEC Technical Report, vol. 50, No. 6, 1997. In this literature, the following are disclosed: a method which uses a projection of wiring edges on the x- and y-axes; a method in which wiring corners are focused on; and a method in which a genetic algorithm is applied. Moreover, as a method adopted in this literature, a matching method in which after the edge is approximated by the straight line, closed areas are extracted, and these closed areas are used for the inspection is described. However, these methods fail to realize an inspection speed that is usable in high-speed inspection, and fail to perform the matching while detecting the deformation quantity of the pattern.

Further, presently, the auto defect classification (ADC) that performs the comparison between an image of a die having a defect (defect image) and an image of the adjacent die corresponding to the die having the defect (reference image) is used. However, unevenness of the luminance of the reference image or the like may affect recognition accuracy. Moreover, in some cases, it is difficult to determine the inside and the outside of the pattern only from the image. In such cases, it is often difficult to distinguish between short circuit and deficiency. In addition, since information as to pattern which is destroyed by the defect cannot be obtained, a fatal defect to the pattern and a mere defect other than such fatal defect cannot be classified.

In the inspection method which uses the die-to-die comparison, as for the position of the defect, the error caused by staging precision of the inspection apparatus and precision of the optical system is unavoidable, and such error is approximately ten or more times the width of the wiring pattern. Due to this fact, even if a defect position is projected onto a pattern that should be formed (design pattern), it is impossible to specify the defect position of the pattern accurately.

Recently, the pattern width of integrated circuits is becoming comparable to wavelengths of the light sources to be used in the exposure process, or even smaller than such wavelengths. In such pattern formation, a method of adding optical proximity correction (OPC) patterns is adopted. In this method, a mask is formed so that the OPC patterns are added to the design data, the exposure is performed using this modified mask, and the manufactured actual pattern on the wafer approximates to the design data.

It is impossible for the conventional die-to-die comparison method to inspect whether or not the OPC patterns effectively serve as corrective modification for the pattern on the wafer. Therefore, there has been a need for a solution for this problem, for example, a method in which the comparative examination between the pattern on the wafer and the design data can be performed in consideration of an allowable pattern deformation quantity.

In addition, in a job shop type production (multi-product small-volume production) as is seen, for example, in a system on chip (SOC), a short delivery time is required. In such a case, even if the systematic defect is found by the electric inspection as a final inspection, a quick countermeasure may not be taken to respond the short delivery time. As a countermeasure of this problem, it is required that the difference between the design data and the formed pattern is monitored in each step of the exposure process. Therefore, there is a need for an inspection method in which pattern deformation that does not affect the electrical characteristic is set as the allowable pattern deformation quantity, and the comparative examination between the design data and the pattern on the wafer can be performed while allowing possible deformations that fall within the allowable pattern deformation quantity.

Further, design check is currently performed using a software program, litho-simulator, etc., for evaluation of the pattern deformation. In order to verify validity of this simulation, comparative examining devices for comparison between the pattern (simulation pattern) outputted by the litho-simulator and the actual pattern are required.

It becomes increasingly important to improve the technology for circuit design by obtaining the pattern deformation quantity to the design data.

At present, a CD-SEM (Critical Dimension Scanning Electron Microscope) is used for controlling the pattern width of the wafer in the manufacturing process of semiconductor integrated circuits. This CD-SEM carries out automatic measurement of the line width of a straight line pattern at a specified position using a line profile for each transfer unit of the stepper called a shot. This measurement is performed in several positions for several shots on several pieces of the wafers for one lot, and whether or not a transfer function of the stepper is normal can be controlled in units of nm (nanometers).

As control items of the circuit pattern, shrink in an endpoint of the wiring, a position of an isolated pattern and the like are also important besides the line width, but the automatic measuring function of the CD-SEM allows only one dimensional measurement. Specifically, the CD-SEM can measure only the length such as the line width. Consequently, the measurement of those two-dimensional shapes is conducted by the operator's visual inspection of the images obtained by the CD-SEM or other microscopes.

Generally, the optical proximity effect correction (OPC) plays an important role not only to secure the line width of the straight line pattern but also to form shapes of the corners and isolated patterns. Furthermore, because of improvement of an operating frequency, presently, the control of the shape of a top end or base of the gate wiring pattern, called an endcap or a field extension, respectively, also becomes important in addition to the gate line width.

Such shape measurement of two-dimensional patterns is essential both in the sampling inspection in the manufacturing process and in a trial production phase, and especially in the trial production phase, it is necessary to inspect the pattern formation on the whole wafer.

However, in a present situation, as described above, the control of the two-dimensional shape is carried out by a human work, and hence automatization is needed for accuracy and productivity.

To meet the above demand, there has been practiced a process of using a scanning electron microscope and making automatic measurements by keeping all scanning directions for an electron beam (charged particle beam) constant in the scanning electron microscope. However, the process is problematic in that it causes a measurement error depending on the direction of beam segments.

### SUMMARY OF THE INVENTION

It is therefore an object of the present invention to provide a pattern inspection apparatus and method which can automatically set various measuring conditions based on reference data by utilizing a reference pattern.

To achieve the above object, according to a first aspect of the present invention, there is provided a pattern inspection apparatus for inspecting a pattern to-be-inspected by comparing the pattern to-be-inspected with a reference pattern, comprising: a storage device for storing the reference pattern; an image generator for scanning the pattern to-be-inspected with a charged particle beam to produce an image of the pattern to-be-inspected; an input device for inputting the image of the pattern to-be-inspected; an inspection device for inspecting the pattern to-be-inspected by comparing an edge of the inputted image of the pattern to-be-inspected and an edge of the stored reference pattern with each other; and an output device for outputting a result of the inspection of the pattern to-be-inspected; wherein the image generator sets a scanning direction for the charged particle beam based on the reference pattern.

In a preferred aspect of the present invention, the scanning direction for the charged particle beam is determined so as to be more perpendicular to all patterns to-be-inspected.

In a preferred aspect of the present invention, the scanning direction for the charged particle beam comprises a scanning direction which is ±90 degrees with respect to the direction which is determined so as to be more perpendicular to the patterns to-be-inspected.

In a preferred aspect of the present invention, the scanning direction for the charged particle beam is determined so as to be more perpendicular to most frequent directions of patterns to-be-inspected.

In a preferred aspect of the present invention, the scanning direction for the charged particle beam comprises a scanning direction which is ±90 degrees with respect to the direction which is determined so as to be more perpendicular to the patterns to-be-inspected.

In a preferred aspect of the present invention, rotated image is acquired by replacing the position of pixels.

According to a second aspect of the present invention, there is provided an image generating apparatus for generating an image of a pattern to-be-inspected by scanning the pattern to-be-inspected with a charged particle beam, comprising: means for scanning a given area of the pattern to-be-inspected to generate a hexagonal image thereof; means for scanning an area, adjacent to the given area, of the pattern to-be-inspected to generate a next hexagonal image thereof; and means for repeatedly scanning successive areas of the pattern to-be-inspected to generate a single image of a wide area of the pattern to-be-inspected.

According to a third aspect of the present invention, there is provided a pattern inspection apparatus for inspecting a pattern to-be-inspected by comparing the pattern to-be-inspected with a reference pattern, comprising: a storage device for storing the reference pattern; an image generator for scanning the pattern to-be-inspected with a charged particle beam to produce an image of the pattern to-be-inspected; an input device for inputting the image of the pattern to-be-inspected; an inspection device for inspecting the pattern to-be-inspected by comparing an edge of the inputted image of the pattern to-be-inspected and an edge of the stored reference pattern with each other; and an output device for outputting a result of the inspection of the pattern to-be-inspected; wherein the image generator scans a wider area of the pattern to-be-inspected by imparting a vertical amplitude to a scanning direction for the charged particle beam.

According to a fourth aspect of the present invention, there is provided a pattern inspection apparatus for inspecting a pattern to-be-inspected by comparing the pattern to-be-inspected with a reference pattern, comprising: a storage device for storing the reference pattern; an image generator for scanning the pattern to-be-inspected with a charged particle beam to produce an image of the pattern to-be-inspected; an input device for inputting the image of the pattern to-be-inspected; an inspection device for inspecting the pattern to-be-inspected by comparing an edge of the inputted image of the pattern to-be-inspected and an edge of the stored reference pattern with each other; and an output device for outputting a result of the inspection of the pattern to-be-inspected; wherein the image generator scans only a pattern portion to be-inspected to determine a deformation quantity of the pattern.

In a preferred aspect of the present invention, the image generator scans only the pattern portion to-be-inspected to reduce a deformation of a profile due to a charge-up effect of the sample.

According to a fifth aspect of the present invention, there is provided a pattern inspection method for inspecting a pattern to-be-inspected by comparing the pattern to-be-inspected with a reference pattern, comprising: storing the reference pattern; scanning the pattern to-be-inspected with a charged particle beam to produce an image of the pattern to-be-inspected, a scanning direction for the charged particle beam being set based on the reference pattern; inspecting the pattern to-be-inspected by comparing an edge of the produced image of the pattern to-be-inspected and an edge of the stored reference pattern with each other; and outputting a result of the inspection of the pattern to-be-inspected.

According to a sixth aspect of the present invention, there is provided a pattern inspection method for inspecting a pattern to-be-inspected by comparing the pattern to-be-inspected with a reference pattern, comprising: storing the reference pattern; scanning the pattern to-be-inspected with a charged particle beam to produce an image of the pattern to-be-inspected, a wider area of the pattern to-be-inspected being scanned by imparting a vertical amplitude to a scanning direction for the charged particle beam by the scanning; inspecting the pattern to-be-inspected by comparing an edge of the produced image of the pattern to-be-inspected and an edge of the stored reference pattern with each other; and outputting a result of the inspection of the pattern to-be-inspected.

According to a seventh aspect of the present invention, there is provided a pattern inspection method for inspecting a pattern to-be-inspected by comparing the pattern to-be-inspected with a reference pattern, comprising: storing the reference pattern; scanning the pattern to-be-inspected with a charged particle beam to produce an image of the pattern to-be-inspected, only a pattern portion to-be-inspected being scanned to determine a deformation quantity of the pattern by the scanning; inspecting the pattern to-be-inspected by comparing an edge of the produced image of the pattern to-be-inspected and an edge of the stored reference pattern with each other; and outputting a result of the inspection of the pattern to-be-inspected.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view, partly in block form, showing a basic arrangement of an image generator in a pattern inspection apparatus according to an embodiment of the present invention;

FIG. 2 is a schematic diagram showing the intensity of secondary electrons detected by a secondary electron detector in the image generator shown in FIG. 1:

FIG. 3 is a schematic diagram showing the manner in which a pattern shown in FIG. 2 is turned 90 degrees and a profile of the pattern is imaged;

FIG. 4 is a schematic diagram showing a scanning area used when patterns are inspected by the pattern inspection apparatus according to the embodiment of the present invention;

FIG. 5 is a schematic diagram illustrative of a measuring accuracy that is obtained when a pattern is scanned horizontally;

FIG. 6 is a schematic diagram illustrative of a measuring accuracy that is obtained when a pattern is scanned vertically in an upward direction;

FIG. 7 is a schematic diagram showing the manner in which a pattern is scanned bidirectionally;

FIG. 8 is a diagram showing an example of a theoretical pattern based on the design data;

FIG. 9 is a diagram showing an example of a pattern that was actually manufactured according to the design data;

FIG. 10 is a diagram showing the outline of the inspection processing that is carried out by a pattern inspection apparatus according to an embodiment of the present invention;

FIG. 11 is a diagram showing an example of hardware construction of the pattern inspection apparatus according to the embodiment of the present invention;

FIG. 12 is a diagram showing the functional block diagram of the pattern inspection apparatus according to the embodiment of the present invention;

FIG. 13 is a flowchart showing an example of recipe registration processing according to the embodiment of the present invention;

FIG. 14 is a diagram showing an example of the correction of a reference pattern;

FIG. 15 is a diagram for explaining a sequential inspection;

FIG. 16 is a diagram for explaining a random inspection;

FIG. 17 is a diagram showing an example of the reference pattern;

FIG. 18 is a diagram showing an example in which the reference pattern of FIG. 17 is converted into edge vectors for respective pixels;

FIG. 19 is a diagram showing an example in which the reference pattern including a curve is converted into the edge vectors;

FIGS. 20A through 20D are a flowchart showing an example of the inspection processing according to the embodiment of the present invention;

FIG. 21 is a diagram showing an example of an image (pattern image to-be-inspected) with contrast attached on the inside of the pattern and on the grounding;

FIG. 22 is a diagram showing edges detected from the image of FIG. 21;

FIG. 23 is a diagram showing an example of an image in which only profile is bright (the pattern image to-be-inspected);

FIG. 24 is a diagram showing the edges detected from the image of FIG. 23;

FIG. 25 is a diagram showing an example of the edge amplitudes of a one-dimensional pattern image to-be-inspected;

FIG. 26 is a diagram showing an example in which the edges of FIG. 25 are dilated;

FIG. 27 is a diagram showing an example of the amplitudes of the edges of the one-dimensional reference pattern;

FIG. 28 is a diagram showing another example in which the edges of FIG. 25 are dilated;

FIG. 29 is a diagram showing another example of the amplitudes of the edge of the one-dimensional reference pattern;

FIG. 30 is a diagram showing another example in which the edges of FIG. 25 are dilated;

FIG. 31 is a diagram showing an example of a smoothing filter;

FIG. 32 is a diagram showing an example of the amplitudes of the edges of a two-dimensional pattern image to-be-inspected;

FIG. 33 is a diagram showing an example in which the edges of FIG. 25 are dilated;

FIG. 34 is a diagram showing another example in which the edges of FIG. 32 are dilated;

FIG. 35 is a diagram showing an example of the edge vectors of the two-dimensional pattern image to-be-inspected;

FIG. 36 is a diagram showing an example in which the edge vectors of FIG. 35 are dilated;

FIG. 37 is a diagram showing another example in which the edge vectors of FIG. 35 are dilated;

FIG. 38 is another diagram of FIG. 17 in which the reference pattern thereof is expressed with the edge vectors for respective pixels;

FIG. 39 is a diagram for explaining the matching;

FIG. 40 is a diagram formed by superimposing FIG. 36 and FIG. 38;

FIG. 41 is a diagram formed by superimposing FIG. 36 and FIG. 38;

FIG. 42A is a diagram showing an example of the reference pattern;

FIG. 42B is a diagram showing an example of the pattern image to-be-inspected;

FIG. 43 is a diagram showing an example in which the spacing of the wiring is identical to that of the grounding;

FIG. 44A is a diagram showing an example of the reference pattern;

FIG. 44B is a diagram showing an example of the relation between the reference pattern of FIG. 44A and the pattern image to-be-inspected;

FIG. 45 is a diagram showing an example of the edges of the pattern image to-be-inspected after the matching was conducted and the edges of the reference pattern;

FIG. 46A is a diagram showing an example of the edges of the reference pattern;

FIG. 46B is a diagram showing an example of the edges of the pattern image to-be-inspected;

FIG. 47 is a diagram showing another example of a technique for giving direction information;

FIG. 48 is a diagram showing an example of the pattern image to-be-inspected;

FIG. 49 is a diagram showing an example of the frequency distribution of the luminance value;

FIG. 50A is a diagram showing an example of the edges of the reference pattern and the edges of the pattern image to-be-inspected;

FIG. 50B is a diagram showing an example in which x components of the vectors d(x, y₀) at y=y₀ between the two edges shown in FIG. 50A are approximated with a regression line D(x);

FIG. 51A is a diagram showing another example of the edges of the reference pattern and the edges of the pattern image to-be-inspected;

FIG. 51B is a diagram showing an example in which the x-components of the vectors d(x, y₀) at y=y₀ between the two edges shown in FIG. 51A are approximated with the regression line D(x);

FIG. 52 is a diagram showing an example of the attributes of the pattern;

FIGS. 53A and 53B are diagrams showing the displacement quantity of the top end, respectively;

FIG. 54 is a diagram showing the displacement quantity of the centroid of the isolated pattern;

FIG. 55A is a diagram showing an example of the corner of the edge of the reference pattern;

FIG. 55B is a diagram showing an example of the corner of the edge of the pattern image to-be-inspected;

FIG. 56 is a diagram showing an example of profile acquisition sections;

FIG. 57 is a diagram showing the curves that demarcate the shape of the exposed pattern obtained by litho-simulator;

FIG. 58 is a diagram showing an enlarged part of FIG. 56 (portion of B);

FIG. 59 is a diagram showing an enlarged part of FIG. 58 (portion of C);

FIG. 60 is a diagram showing an example of the profile;

FIGS. 61A and 61B are diagrams showing examples in which the second edge positions (points) are approximated with curves and the second edges are obtained;

FIG. 62A is a diagram showing another example of the profile acquisition sections;

FIG. 62B is a diagram showing an example of the relation between the first edges of the pattern image to-be-inspected and the second reference pattern;

FIG. 63 is a diagram showing an example in which the measurement is conducted using a high-magnification image and a low-magnification image.

FIGS. 64A, 64B, and 64C are schematic diagrams showing the manner in which a scanning direction for an electron beam is 45 degrees and −45 degrees;

FIGS. 65A and 65B are schematic diagrams showing the manner in which a scanning direction for an electron beam is 18 degrees;

FIGS. 66A through 66D are schematic diagrams illustrative of a process of scanning a given area of a pattern to generate an image of a predetermined shape thereof, scanning an area, adjacent to the given area, of the pattern to generate a next image of a predetermined shape thereof, and repeatedly scanning successive areas of the pattern to generate a single image of a wide area of the pattern;

FIG. 67 is a schematic diagram illustrative of a process of determining a scanning direction for an electron beam based on a reference pattern;

FIG. 68 is a schematic diagram showing a scanning path for an electron beam;

FIG. 69 is a schematic diagram showing a scanning path for an electron beam;

FIG. 70 is a schematic diagram showing the filtering of a vertical scan;

FIG. 71 is a schematic diagram showing the manner in which only an edge is scanned;

FIG. 72 is a flowchart of the steps of a process of scanning an edge;

FIGS. 73A and 73B are diagrams illustrative of processes of sequencing the acquisition of measured data when only an edge is scanned;

FIG. 74 is a view showing a method in which lines, ends, and corners to-be-inspected are classified from either the image scanned at 0 degree or the image scanned at 90 degrees, and the obtained results are summed;

FIG. 75 is a view showing a method in which the rotated image is acquired only by replacing the positions of pixels; and

FIG. 76 is a view showing a method in which the rotated image is acquired only by replacing the positions of pixels.

### DETAILED DESCRIPTION OF THE PREFERRED EMBODIMENTS

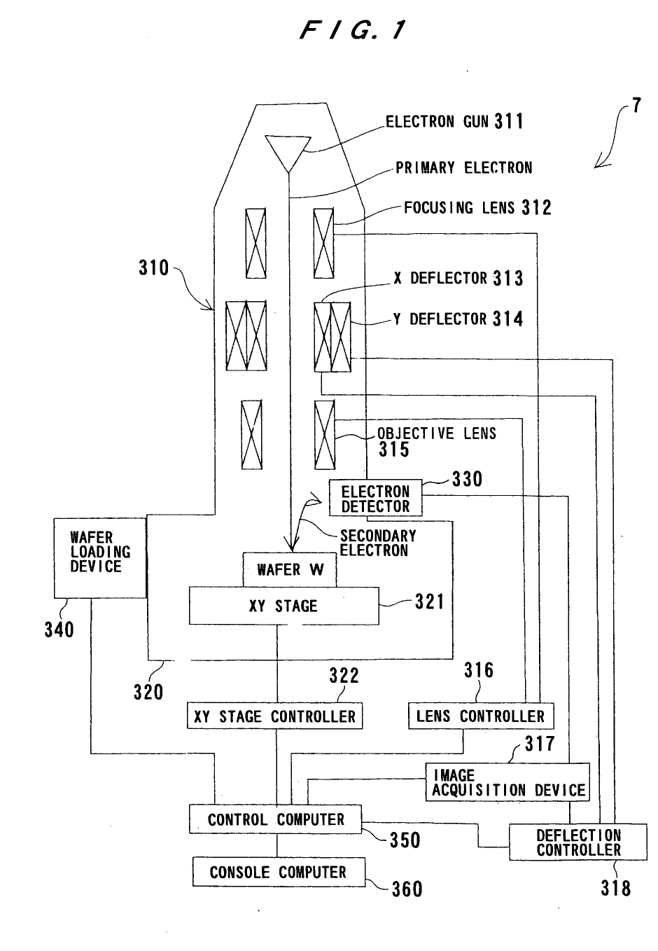

FIG. 1 schematically shows, partly in block form, a basic arrangement of an image generator 7 in a pattern inspection apparatus according to an embodiment of the present invention. As shown in FIG. 1, the image generator 7 generally comprises an irradiation system 310, a specimen chamber 320, and a secondary electron detector 330.

The irradiation system 310 comprises an electron gun 311, a focusing lens 312 for focusing primary electrons emitted from the electron gun 311, an X deflector 313 and a Y deflector 314 for deflecting an electron beam (charged particle beam) in X and Y directions, respectively, and an objective lens 315. The specimen chamber 320 has an XY stage 321 movable in the X and Y directions. A wafer W as a specimen can be loaded into and out of the specimen chamber 320 by a wafer loading device 340.

In the irradiation system 310, primary electrons emitted from the electron gun 311 are focused by the focusing lens 312, deflected by the X deflector 313 and the Y deflector 314, and focused and applied by the objective lens 315 to the surface of the wafer W. When the primary electrons are applied to the wafer W, the wafer W emits secondary electrons, which are detected by the secondary electron detector 330.

The focusing lens 312 and the objective lens 315 are connected to a lens controller 316 that is connected to a control computer 350. The secondary electron detector 330 is connected to an image acquisition device 317 that is also connected to the control computer 350. The X deflector 313 and the Y deflector 314 are connected to a deflection controller 318 that is also connected to the control computer 350. The XY stage 321 is connected to an XY stage controller 322 that is also connected to the control computer 350. The wafer loading device 340 is also connected to the control computer 350. The control computer 350 is connected to a console computer 360.

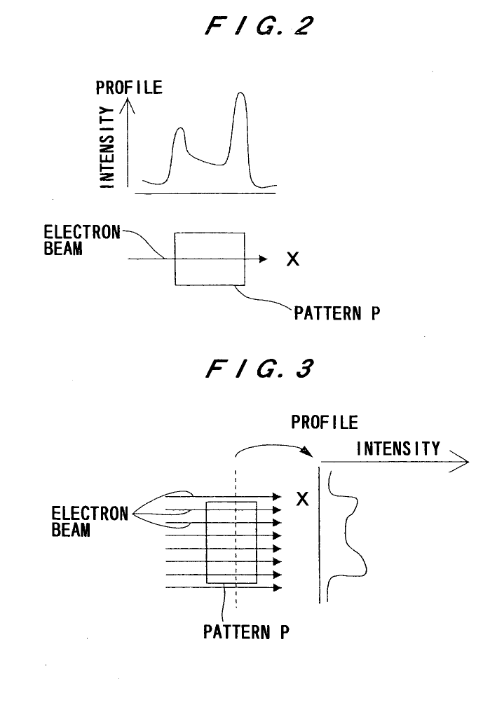

FIG. 2 schematically shows the intensity of secondary electrons detected by the secondary electron detector 330 shown in FIG. 1. Specifically, FIG. 2 shows the intensity of secondary electrons that are detected by the secondary electron detector 330 when a pattern P is scanned by one electron beam in the X direction. As shown in FIG. 2, the intensity of secondary electrons is stronger at edges of the pattern P due to an edge effect, and weaker at a central area of the pattern P. The intensity of secondary electrons is not symmetrical horizontally across the pattern P, but is observed with a lower level at the edge (left edge) where the electron beam starts scanning the pattern P than at the opposite edge (right edge) where the electron beam leaves the pattern P.

FIG. 3 schematically shows the manner in which the pattern P shown in FIG. 2 is turned 90 degrees and a profile of the pattern is imaged. Specifically, FIG. 3 shows the intensity of secondary electrons that are detected by the secondary electron detector 330 when the pattern P is scanned by a plurality of electron beams in the X direction. As shown in FIG. 3, it is difficult to obtain an edge effect at the edges of the pattern P parallel to the scanning direction, compared with the intensity of secondary electrons shown in FIG. 2.

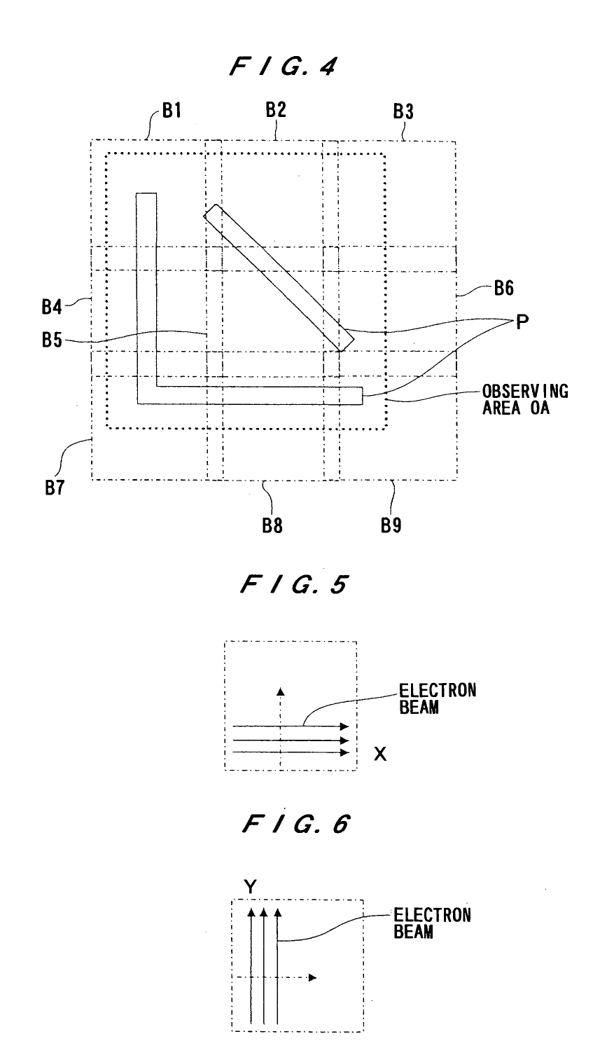

FIG. 4 schematically shows a scanning area used when patterns are inspected by the pattern inspection apparatus according to the embodiment of the present invention. In FIG. 4, patterns P to-be-inspected are indicated by the solid lines. A square block indicated by the dot-and-dash lines represents an area (scanning area) which is obtained by a single scanning process. In FIG. 4, the square block comprises nine blocks B1 through B9 arranged in a matrix of three vertical columns and three horizontal rows. An observing area OA is indicated by the dotted lines.

FIG. 5 is illustrative of a measuring accuracy that is obtained when a pattern is scanned horizontally (in the X direction). As shown in FIG. 5, when a pattern is scanned horizontally, the measuring accuracy is high with respect to a vertical line as with the measuring accuracy shown in FIG. 2, but is low with respect to a horizontal line.

FIG. 6 is illustrative of a measuring accuracy that is obtained when a pattern is scanned vertically in an upward direction (in the Y direction). As shown in FIG. 6, when a pattern is scanned vertically, the measuring accuracy is high with respect to a horizontal line, but is low with respect to a vertical line.

In a lower left block B7 where there are both vertical and horizontal patterns as shown in FIG. 4, if the measuring accuracy needs to be high with respect to both vertical and horizontal lines, then two scans including the horizontal scan shown in FIG. 5 and the vertical scan shown in FIG. 6 are required to be performed. In a block B8 which is to the right of the block B7 where there is only a horizontal pattern, the measuring accuracy is high when only the vertical scan shown in FIG. 6 is performed. In a middle left block B4 where there is only a vertical pattern, the measuring accuracy is high when only the horizontal scan shown in FIG. 5 is performed. By thus selectively performing a horizontal scan, a vertical scan, or two horizontal and vertical scans, a desired image of a pattern is obtained under the scan control.

If the scanning direction is 0 degree (the X direction), the accuracy of detecting edges of a pattern extending in the X direction (horizontal) is low. If the scanning direction is 90 degrees (the Y direction), the accuracy of detecting edges of a pattern extending in the Y direction (vertical) is low. Therefore, for achieving a high level of accuracy of detecting edges of a pattern, it is necessary to scan the pattern in two directions, i.e., at 0 degree and 90 degrees. Since most of the patterns on semiconductor devices (LSI circuits) and liquid crystal display panels comprise patterns extending horizontally (in the X direction) and patterns extending vertically (in the Y direction), those patterns need to be scanned in two directions, i.e., the X direction (0 degree) and the Y direction (90 degrees), for detecting the patterns with high accuracy.

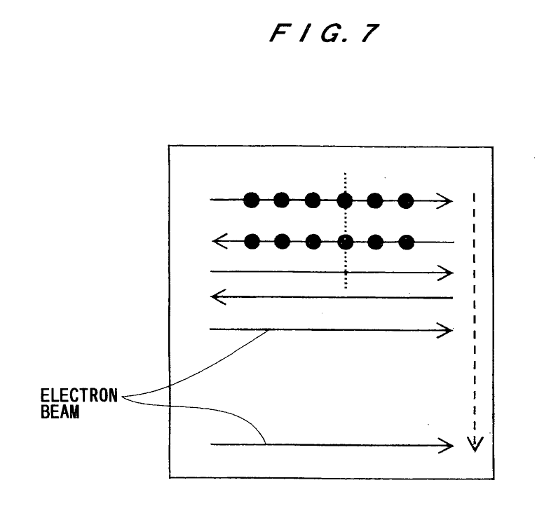

FIG. 7 schematically shows the manner in which a pattern is scanned bidirectionally. It has been explained with respect to FIGS. 2 through 6 that unless a scanning beam and a pattern to be scanned cross each other, the measuring accuracy is low because sufficient luminance due to an edge effect is not available. The measuring accuracy tends to be lower at the edge (left edge in FIG. 2) where the scanning beam starts scanning the pattern than at the opposite edge (right edge in FIG. 2) where the scanning beam leaves the pattern. In view of these observations, an image is acquired by scanning the pattern in alternately opposite directions as shown in FIG. 7. Specifically, an image is acquired by scanning the pattern alternately at 0 degree and −180 degrees. The edge of a pattern where the scanning beam starts scanning the pattern is measured based on data obtained when the leftward scan is made, and the opposite edge of the pattern is measured based on data obtained when the rightward scan is made. Consequently, high accuracy can be achieved at both the edges of the pattern.

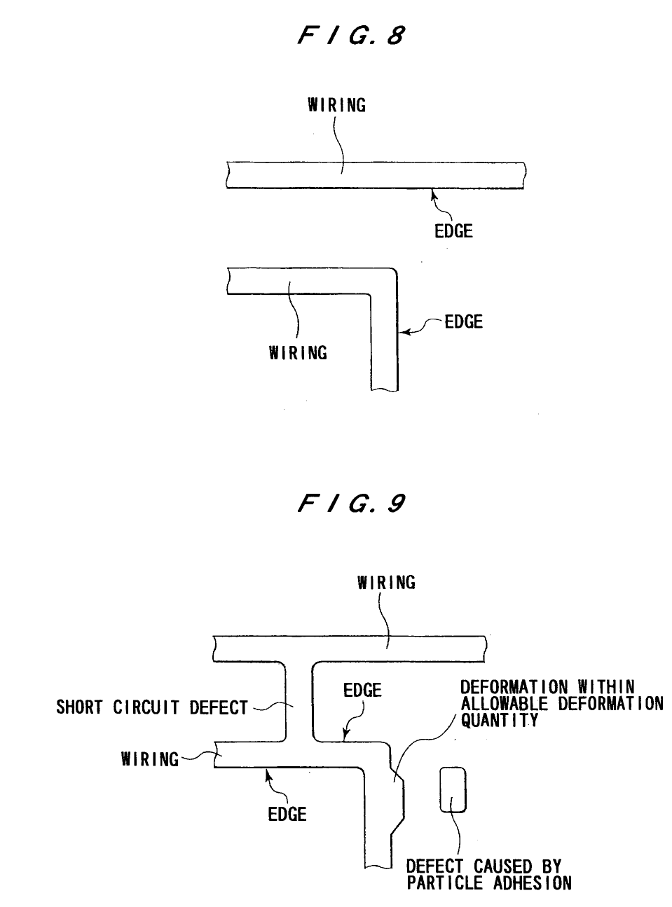

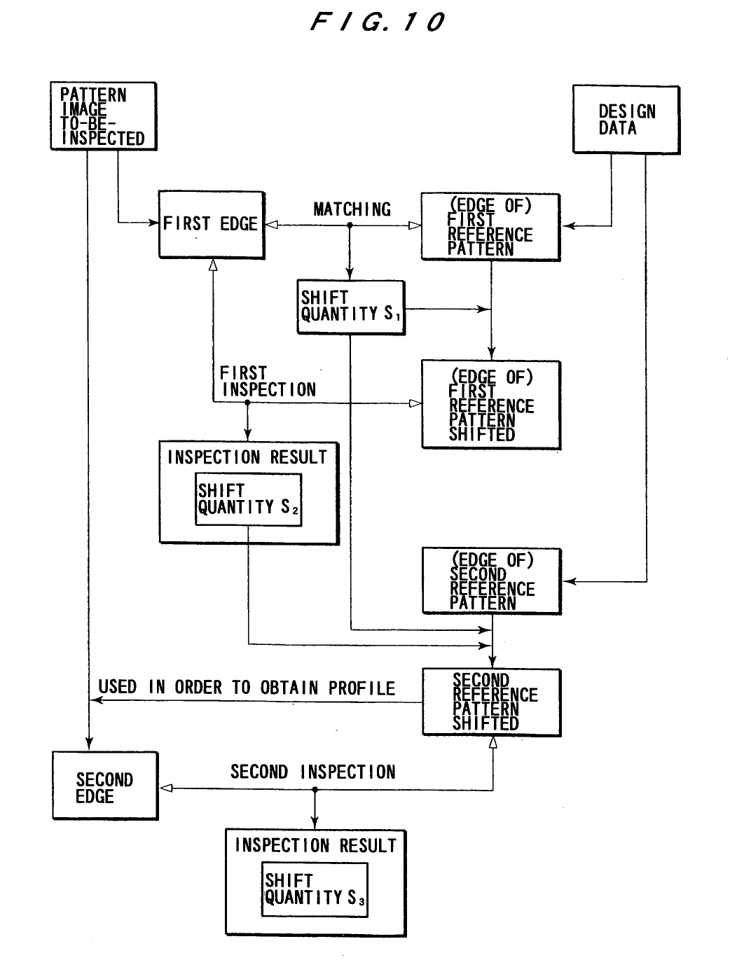

The pattern inspection apparatus according to the present embodiment performs the inspection by comparing a pattern to-be-inspected (for example, the pattern shown in FIG. 9) with a reference pattern (for example, the pattern shown in FIG. 8).

As described above with reference to FIGS. 2 through 7, the image generator generates an image of a pattern to be-inspected according to one of the following three scanning processes:

(Scan-1 process): Unidirectional scan at 0 degree, 90 degrees, or 18 degrees;

(Scan-2 process): Alternate scan at 0 degree and 180 degrees; and

(Scan-3 process): Bidirectional scan at 0 degree and 90 degrees or bidirectional scan at 45 degrees and −45 degrees.

The coordinate system that is employed has its X-axis extending in the rightward direction and its Y-axis extending in the upward direction, with most frequent directions of the pattern to-be-inspected being rightward (0 degree).

A process of inspecting a pattern by comparing the pattern to-be-inspected and a reference pattern with each other will be described below.

With regard to the direction of the edge, it is possible to interpret as directions of actually obtained angle, and the actually obtained angle plus 180 degrees. Therefore, the direction is uniquely determined by defining the direction in which the interior of the pattern is located on the right-hand side. This will be described with reference to FIG. 4. For example, in the block B4, there are two edges extending vertically, and the left side edge is defined as 90 degrees, and the right side edge is defined as 270 degrees.

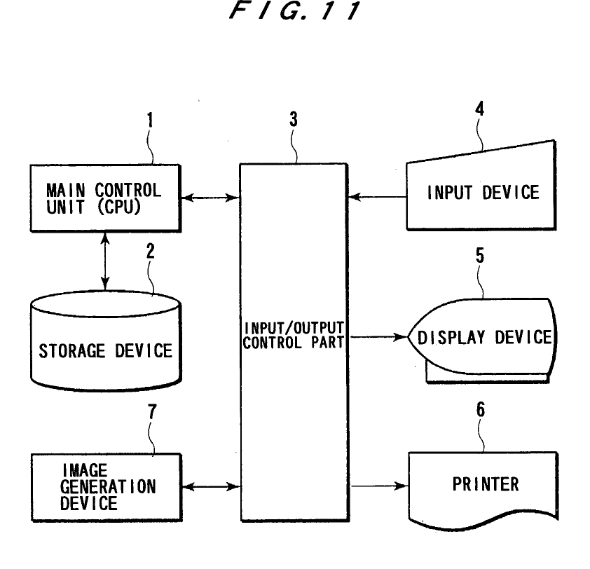

FIG. 10 shows, in block form, an inspecting process which is carried out by the pattern inspection apparatus according to the embodiment of the present invention. In the inspecting process, a first edge is detected from an image of the pattern to-be-inspected.

According to the unidirectional scan of (Scan-1 process) and the alternate scan of (Scan-2 process), an edge is detected from a single image. According to the bidirectional scan of (Scan-3 process), edges are detected from two images, and the detected edge information is merged. Specifically, according to the bidirectional scan at 0 degree and 90 degrees, only an edge (or edges) having an angle from 45 degrees to 135 degrees and an angle from 225 degrees to −45 degrees is extracted from an image scanned at 0 degree, and only an edge (or edges) having an angle from 135 degrees to 225 degrees and an angle from −45 degrees to 45 degrees is extracted from an image scanned at 90 degrees, and all edges are combined into total edges that are handled as edges obtained from a single image. According to the bidirectional scan at 45 degrees and −45 degrees, only an edge (or edges) having an angle from 90 degrees to 180 degrees and an angle from 270 degrees to 360 degrees is extracted from an image scanned at 45 degrees, and only an edge (or edges) having an angle from 0 degree to 90 degrees and an angle from 180 degrees to 270 degrees is extracted from an image scanned at −45 degrees, and all edges are combined into total edges that are handled as edges obtained from a single image.

Then, by comparing the first edge and the edge of the first reference pattern, the matching between the pattern image to-be-inspected and the reference pattern is performed. As a result of the matching, the shift quantity S₁ is obtained, and the first reference pattern is shifted by using this shift quantity S₁. Subsequently, by comparing the first edge and the shifted first reference pattern, the pattern to-be-inspected (actual pattern) is inspected. At this first stage of inspection, the pattern deformation quantity is obtained and the defect is detected. The shift quantity S₂ is obtained as one of the pattern deformation quantities.

Then, in order to detect the second edges from the pattern image to-be-inspected, the corresponding second reference pattern is shifted by the shift quantity S₁+S₂. By using the shifted second reference pattern, profiles are obtained on the pattern image to-be-inspected and the second edges are detected.

According to the unidirectional scan of (Scan-1 process), a profile is determined from one image.

According to the alternate scan at 0 degree and 180 degrees of (Scan-2 process), a profile for obtaining a right edge (an edge at an angle from 180 degrees through 360 degrees) is determined from an image scanned at 0 degree, and a profile for obtaining a left edge (an edge at an angle from 0 degree through 180 degrees) is determined from an image scanned at 180 degrees.

According to the bidirectional scan of (Scan-3 process), a profile for obtaining an edge (or edges) having an angle from 45 degrees to 135 degrees and an angle from 225 degrees to −45 degrees is determined from an image scanned at 0 degree, and a profile for obtaining an edge (or edges) having an angle from 135 degrees to 225 degrees and an angle from −45 degrees to 45 degrees is determined from an image scanned at 90 degree.

Specifically, lines, ends, and corners to-be-inspected are classified from either the image scanned at 0 degree or the image scanned at 90 degrees, and the obtained results are summed. In this example, the lines, the ends, and the corners which have a vertical direction (90 degree or 270 degrees), a direction which is inclined upwardly to the left (135 degrees), and a direction which is inclined downwardly to the right (−45 degrees) should be inspected from an image scanned at 0 degree. Further, the lines, the ends, and the corners which have a horizontal direction (0 degree or 180 degrees), a direction which is inclined upwardly to the right (45 degrees), and a direction which is inclined downwardly to the left (225 degrees) should be inspected from an image scanned at 90 degree.

FIG. 74 is a view showing the above example.

According to the bidirectional scan at 45 degrees and −45 degrees, a profile for obtaining an edge between an angle from 90 degrees through 180 degrees and an angle from 270 degrees through 360 degrees is determined from an image scanned at 45 degrees, and a profile for obtaining an edge between an angle from 0 degree through 90 degrees and an angle from 180 degrees through 270 degrees is determined from an image scanned at −45 degrees.

The second edge and the edge of the shifted second reference pattern are compared with each other, thus inspecting the pattern to-be-inspected. In the second inspecting process, a pattern deformation quantity is also determined and a defect is also detected. A shift quantity S₃ is determined as one of the pattern deformation quantities.

In the case where the image is acquired by scanning at 45 degrees or −45 degrees, there is rotation between the acquired image and the reference pattern, and hence it is necessary to compensate for such rotation. According to one method, the reference pattern is rotated. Since the reference pattern is rotated, the inclined image becomes final output image, and thus such image is difficult to see. Therefore, the method in which the image is rotated is employed. However, in the case where scanning is made so as to perform sampling uniformly in X and Y directions, if the acquired image is rotated, interpolated values between pixels must be used as values of the rotated image. In this case, the acquired image may be unsharp by interpolation, and hence in this embodiment, the rotated image is acquired only by replacing the positions of pixels without using interpolation. However, in this method, it is impossible to obtain the rotated image by the scanning method in which sampling is performed at the normal vertical and horizontal same intervals, and thus it is necessary to employ the following scanning method.

FIG. 75 shows a specific example in which an image is produced according to the above method. The 45 degree inclination scanning method on the left side and the 45 degree inclination image on the right side are the same which are depicted by rotation of 45 degrees. The final image to be acquired is the image on the right side. In FIG. 75, grid points of a chessboard show the positions of images to be acquired by uniform sampling in X and Y directions. Solid circles (●) correspond to data of actual sampling, and in the locations where there is no solid circle, pixel values cannot be acquired. In order to acquire the image on the right side, the scanning method in the left side is performed. In this case, the sampling intervals S in the X direction are the same in each scanning line, but the sampling intervals in the Y direction are half of the sampling interval S in the X direction. Between odd-numbered lines and even-numbered lines, the sampling interval is shifted by half of the sampling interval S in the X direction. This sampling interval S is obtained by multiplying the pixel interval on the right side by \sqrt{2}. In this manner, a desired image can be obtained only by rotating of the left side view. In this case, it is necessary to put values in the order different from the actual sampling order.

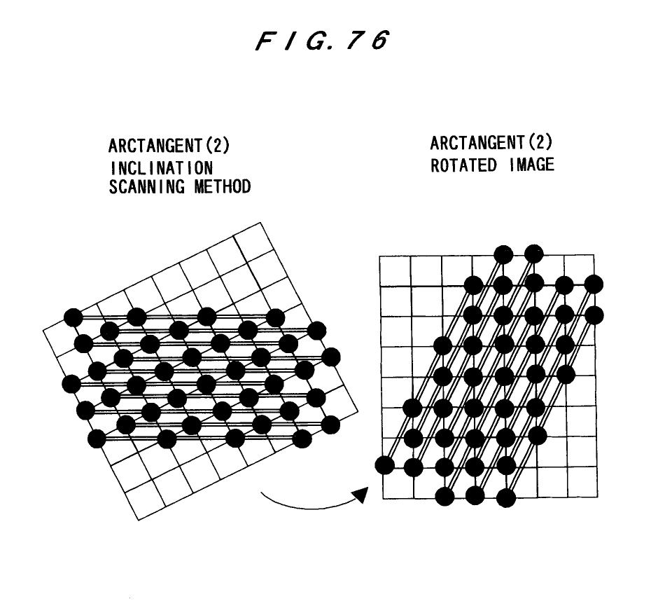

Although FIG. 75 shows the case in which scanning is performed at 45 degrees, FIG. 76 shows the inclination scanning method of arctangent(2) and the rotated image.

FIG. 11 is a diagram showing an example of hardware configuration of the pattern inspection apparatus in this embodiment. The pattern inspection apparatus according to this embodiment comprises a main control unit 1, a storage device 2, an input/output control unit 3, an input device 4, a display device 5, a printer 6, and an image generator 7 shown in FIG. 1.

The main control unit 1 comprises a CPU and the like, and manages and controls the whole apparatus. The main control unit 1 is connected to the storage device 2. The storage device 2 can take a form of a hard disk drive, a flexible disk drive, an optical disc drive, or the like. Further, the input device 4 such as a keyboard or a mouse, the display device 5 such as a display for displaying the input data, calculation results, and the like, and the printer 6 for printing the calculation results and the like are connected to the main control unit 1 through the input/output control unit 3.

The main control unit 1 has a control program such as an OS (Operating System), a program for the pattern inspection, and an internal memory (internal storage device) for storing necessary data and the like, and realize the pattern inspection with these programs and the like. These programs can be initially stored in a flexible disk, a CD-ROM disc, etc., read and stored in a memory, a hard disk, or the like before execution, and then executed.

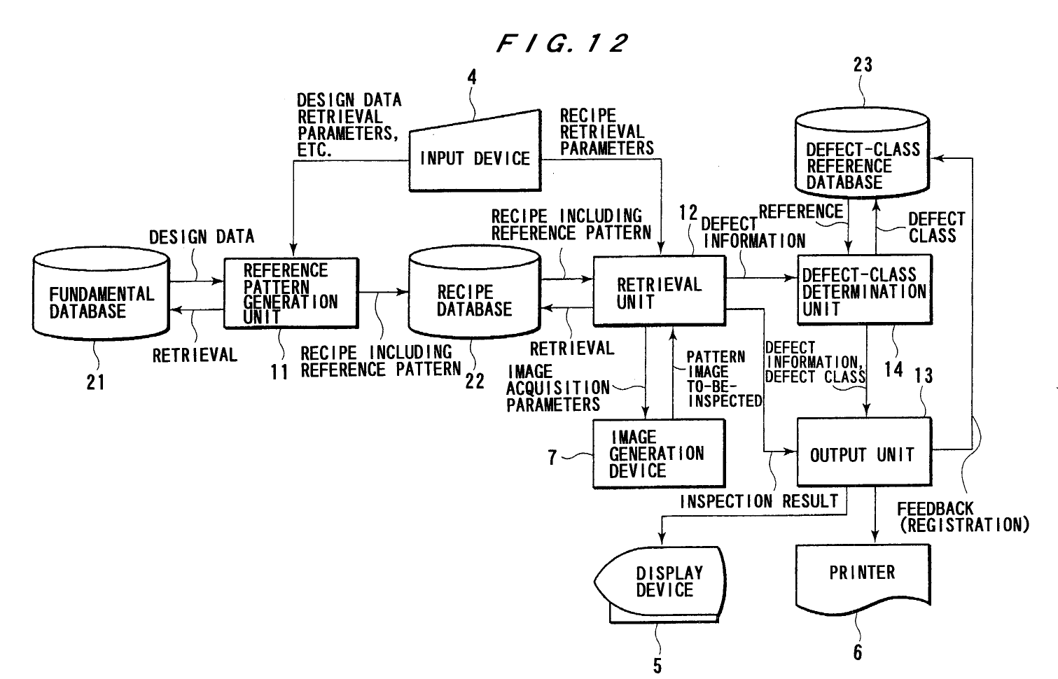

FIG. 12 is a diagram showing a functional block diagram of the pattern inspection apparatus in this embodiment. A reference pattern generation unit 11, an inspection unit 12, an output unit 13, and a defect-class determination unit 14 are all realized by programs. A fundamental database 21, a recipe database 22, and a defect-class reference database 23 are provided in the storage device 2.

Alternatively, the fundamental database 21 may be provided outside the storage device 2 and the pattern inspection apparatus may access the fundamental database 21 through the LAN.

(Recipe)

Before the inspection, first, a set of inspection parameters called a recipe is set. The parameters include the distance between the pixels on the actual pattern (pixel distance) when acquiring the pattern image to-be-inspected that is the object of the inspection, the number of pixels such as 512×512 or 1024×1024, and the like. From these values, the distance on the actual pattern of the image (image size) that is to be processed collectively can be found. Moreover, the parameters for detecting the edge and the parameters for determining the defect are set.

As data to be compared with the pattern image to-be-inspected, the design data is used. As this design data, the data obtained by modifying CAD layout data of a GDS format through layer-merging or fracturing can be used. In this embodiment, a bundle of line segments obtained by this processing is clipped with an rectangular area whose one side is equal to the side of the image size plus an error of the stage and the maximum parallel shift quantity of the pattern to define the reference pattern, which is stored in the recipe database 22 beforehand. If the error of the stage can be neglected compared to the maximum parallel shift quantity of the pattern, the absolute coordinate values of the pattern deformation can be measured. In this embodiment, the reference pattern is set to be larger than the pattern image to-be-inspected in consideration of the error of the stage and the maximum parallel shift quantity of the pattern to perform the processing. Alternatively, the pattern image to-be-inspected may be set to be larger than the reference pattern to perform the processing.

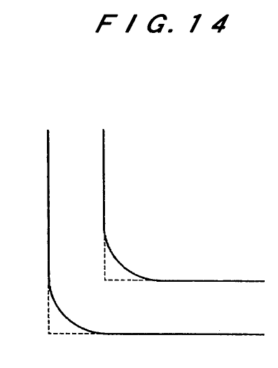

The corners of the reference pattern may undergo rounding processing. As shown in FIG. 14, normally the design data consists of polygons having acute angles (dotted lines in FIG. 14), whereas circuit patterns actually formed have rounded corners. To make up this difference, the corners may be corrected so as to be close to the actual patterns by applying a circle, an ellipse, a straight line, or a curve described by other method to the corner parts.

If the design data is used as the reference pattern, the comparison becomes defect inspection in which the actual pattern image is compared with the pattern that should be realized. In this case, the allowable quantity that does not affect the electrical characteristic is set as the allowable pattern deformation quantity. This pattern deformation quantity may be set for each attribute of the wiring, and furthermore may be altered for a portion where the patterns are crowded and for a portion where the patterns are not crowded.

If a curve (solid lines in FIG. 57) demarcating the shape of the exposed pattern obtained by litho-simulator is used as the reference pattern, the defect inspection can be performed while the validity of the simulation is being examined. Output data of litho-simulator is a light intensity distribution obtained through optical simulation. The curves of the shape are obtained from this distribution. In this case, for the allowable pattern deformation quantity, an error that is allowed in the simulation is set.

In this embodiment, the design data is used as the reference pattern.

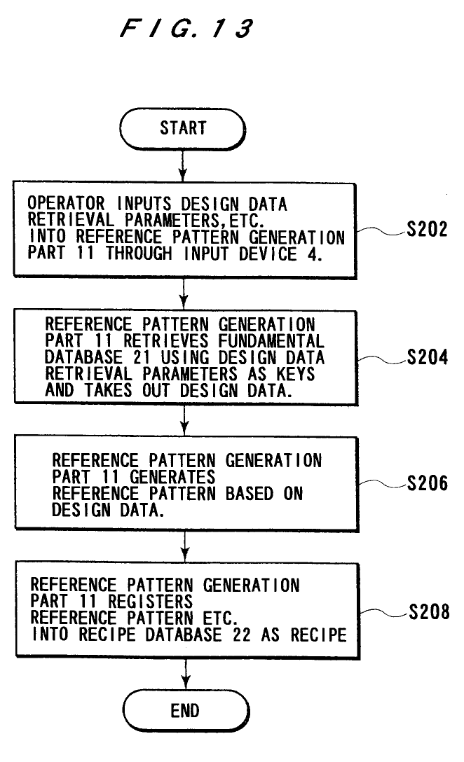

FIG. 13 is a flowchart showing an example of recipe registration processing in this embodiment. First, the operator inputs parameters into the reference pattern generation unit 11 via the input device 4. The parameters include parameters for retrieving design data (here, parameters for specifying the kind of a sample to-be-inspected, and the process), inspection mode, image acquisition parameters (inspection area, image size, the number of pixels, slot number for specifying the wafer, and adjustment parameters of the optical system), and parameters for detecting and inspecting the edge (step S202).

As parameters for detecting and inspecting the edge, the following information is set:

(R1) Pattern deformation quantities to calculate

(R2) Limits of the negative side and the positive side of the allowable pattern deformation quantity and a limit of the allowable directional difference of the edge

(R3) Parameters of the edge detection, which are empirically determined from the image quality

(R4) An extraction rule for automatically determining the attribute of the pattern (corner, line part, end point, isolated pattern, etc.)

(R5) A length of the profile acquisition section, an interval between the profile acquisition sections, an interval between positions where the luminance is checked within the profile acquisition section, a method for taking the profile (whether or not the threshold method is used, and the like)

(R6) A flag for indicating whether or not the profile acquisition sections are set to be variable and are to be determined when measuring

The reference pattern generation unit 11 retrieves the fundamental database 21 using design data retrieval parameters (the kind of the sample to-be-inspected, and the process) as a key and takes out the design data (step S204). The fundamental database 21 serves as a database that stores the design data (CAD data) corresponding to the pattern image to-be-inspected.

Next, the reference pattern generation unit 11 generates the reference pattern based on the design data (step S206).

In this step, in some cases, it is necessary to modify the design data so as to be optimum for the positions of the edges that are detected from the pattern image to-be-inspected by conducting shrink processing (processing in which the magnification of the pattern image is altered), size processing (processing in which the line width is altered), etc., on the design data. Furthermore, since the position of the edge to-be-detected is generally different in the first edge detection and in the second edge detection, if necessary, two kinds of the reference patterns are prepared for the first edge detection and for the second edge detection.

Since the inspection is performed for each inspection unit area that is obtained through the division of the inputted area to-be-inspected by an image size, the reference pattern is produced in accordance with the inspection unit area. The inspection includes a sequential inspection and a random inspection.

FIG. 15 is a diagram for explaining the sequential inspection. The inspection area is normally determined as a sum of rectangles. That is, since the inspection area is not set on the whole wafer, but is set on a plurality of areas which are specified by rectangles (the upper short rectangle, the lower long rectangle, etc. as in FIG. 15), the sequential scanning is executed for each inspection unit area in order to perform a high-speed inspection on that area. The reference pattern is produced for each inspection unit area.

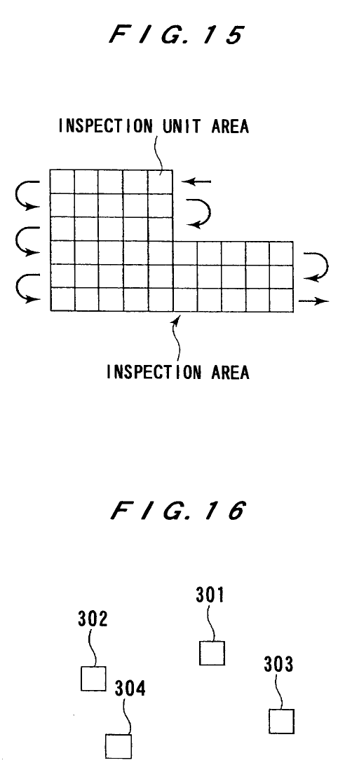

FIG. 16 is a diagram for explaining the random inspection. In the random inspection, a certain area is not inspected sequentially, but is inspected in a pinpoint manner. In FIG. 16, only the inspection unit areas 301 to 304 are inspected.

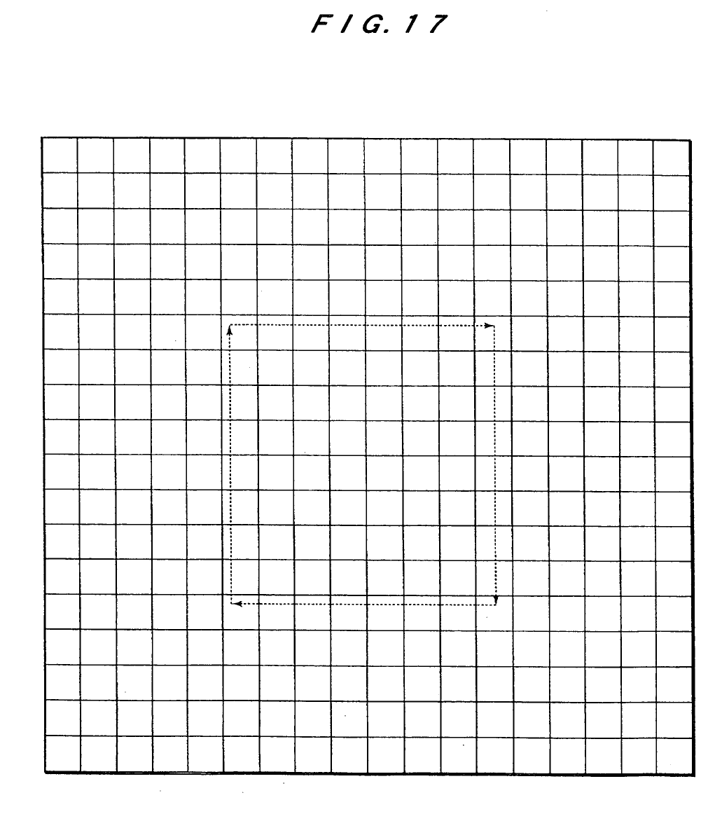

FIG. 17 is a diagram showing an example of the reference pattern, and FIG. 18 is a diagram showing an example in which the reference pattern of FIG. 17 is converted into the edges vectors for respective pixels. In FIG. 17, the reference pattern (dotted lines) is shown with a sub pixel accuracy. Normally, the edge direction of the reference pattern is parallel to a lateral direction (x-direction) or a longitudinal direction (y-direction) of the pixel. The edge of the reference pattern, as with the edge of the pattern image to-be-inspected, has information of a starting point (with a sub pixel accuracy), a direction, and the amplitude for each pixel. In this embodiment, the edge amplitude of the reference pattern is set to unity, i.e. 1 for all pixels.

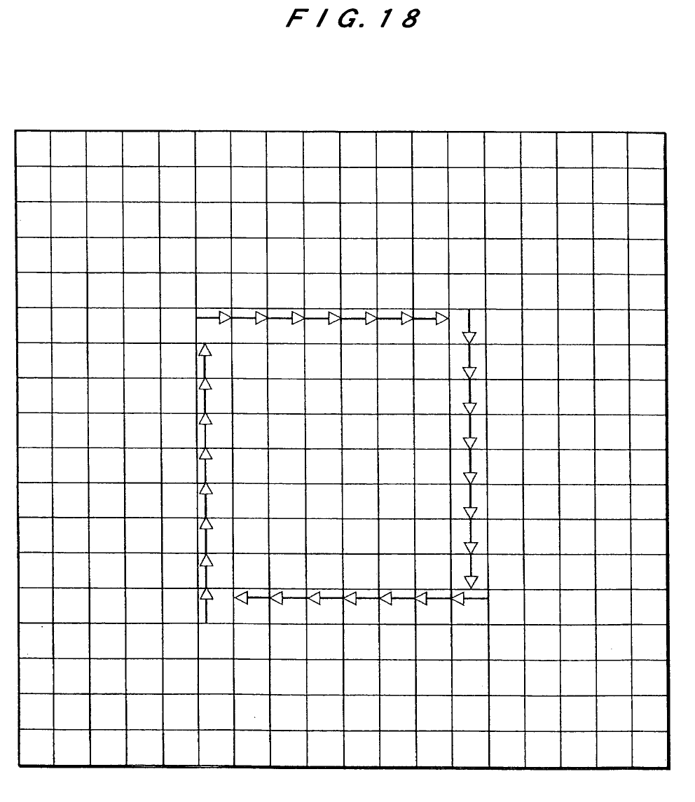

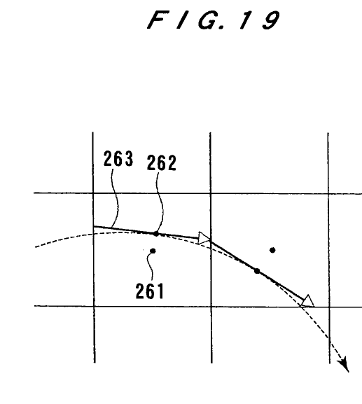

As shown in FIG. 19, the reference pattern may include a curve. For converting the reference pattern including the curve into the edge vector, there is, for example, a method in which a tangent line 263 at a point 262 that is on the reference pattern and is closest to the center 261 of the pixel is taken as the edge vector.

Next, the reference pattern generation unit 11 registers the reference pattern, the kind of the sample to be-inspected, the process, the inspection mode, the image acquisition parameters, and the parameters for detecting and inspecting the edge in the recipe database 22 (step S208). These data are called a recipe which is a set of inspection parameters and are controlled using the kind, the process, and the inspection mode as a key.

(Inspection Processing)

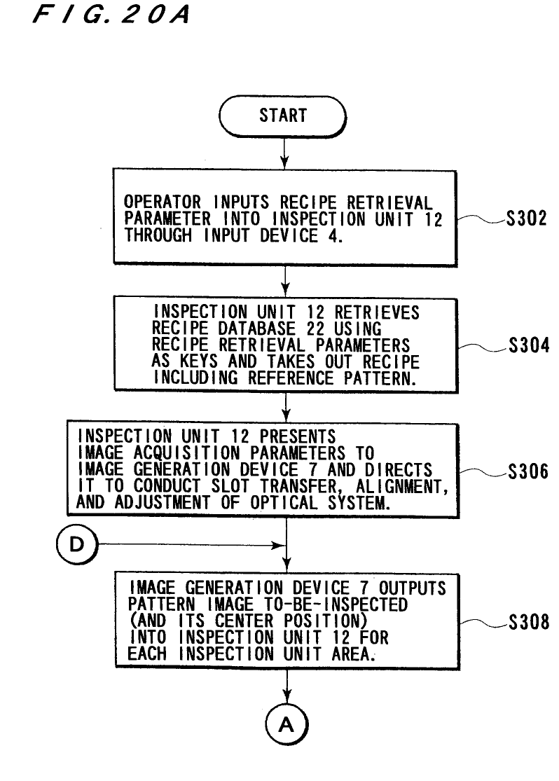

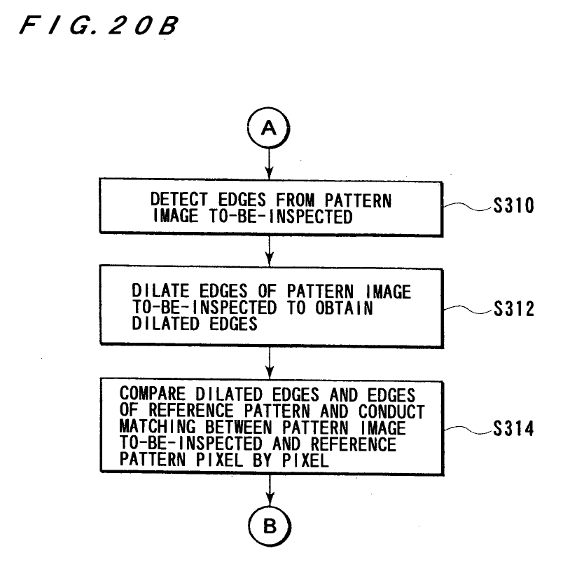

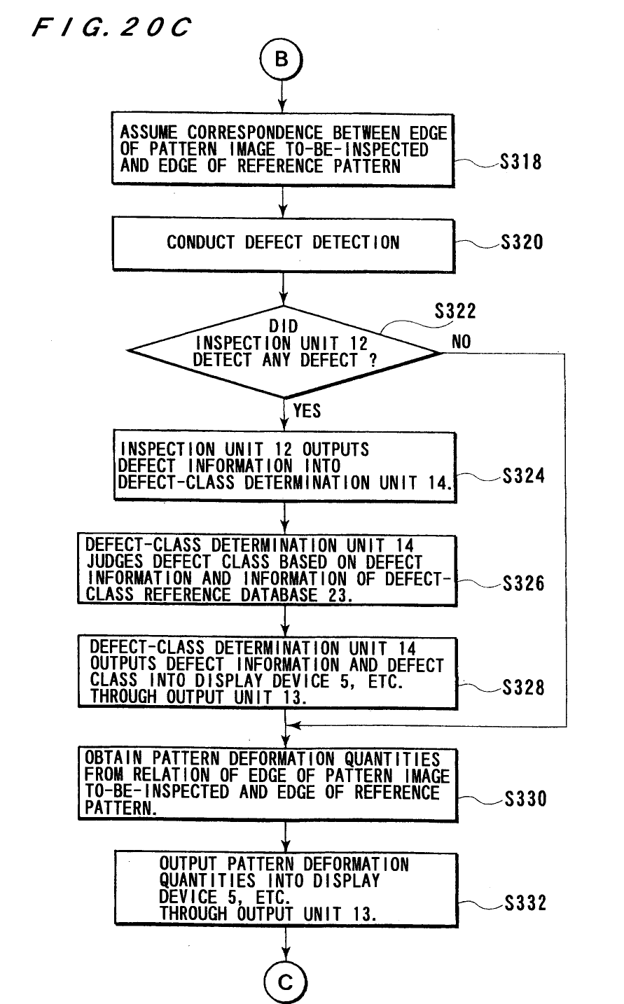

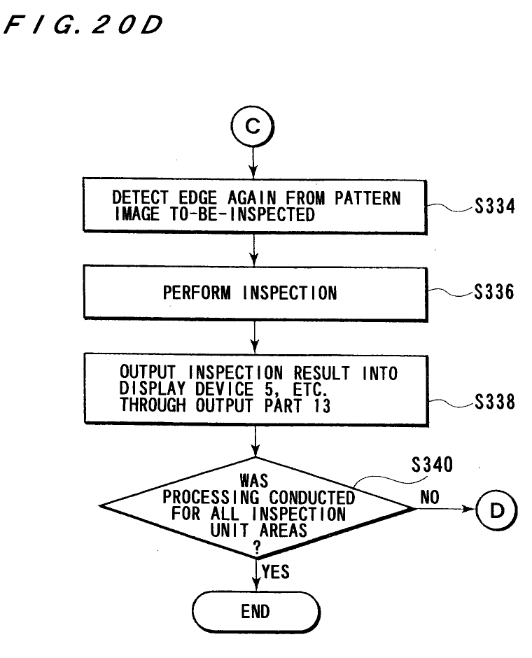

FIGS. 20A through 20D is a flowchart showing an example of the inspection processing in this embodiment. First, the operator inputs recipe retrieval parameters (in this case, the kind, the process, and the inspection mode) into the inspection unit 12 through the input device 4 (step S302).

The inspection unit 12 retrieves the recipe database 22 using the recipe retrieval parameters as a key and takes out the recipe (step S304). Then, in order to acquire the pattern image to-be-inspected (optical image, electron beam image, focused ion beam image, probe microscope image, etc.), the inspection unit 12 gives the image acquisition parameters to the image generator 7 and directs the image generator 7 to conduct slot transfer, alignment, and adjustment of an optical system (step S306). Here, the alignment means a function of obtaining a conversion coefficient between the coordinate system that is used by the CAD data and the coordinate values for controlling an observation position of the real wafer. This function has been embodied by CAD navigation. The CAD navigation is a well-known method in which after the alignment, the coordinate values of the position on the CAD data which should be observed are converted into the coordinate values for controlling the observation position of the real wafer, the field of view of an imaging apparatus is moved to that position, and the image at the position is acquired.

As the image generator 7, a scanning electron microscope shown in FIG. 1 is most preferable. Various scanning microscopes such as a scanning focus ion beam microscope, a laser scanning microscope, or a probe scanning microscope, or various microscopes may be used.

The image generator device 7 outputs the pattern image to-be-inspected (and its center position) to the inspection unit 12 for each inspection unit area (step S308)

(The First Edge Detection)

Next, the inspection unit 12 conducts the first edge detection from the pattern image to-be-inspected (step S310) For the edge detection, there are, for example, the following two techniques.

(A) One is a technique suitable for the case where the contrast exists between the inside of the pattern and the grounding. In many of such images, the edges can be detected through binarization processing, but in the case where the contrast is relatively indistinct, the edges cannot be detected clearly. In this case, for example, by application of a method disclosed in the literature [reference 1]:R. M. Haralick, “Digital step edges from ZERO crossing of second directional derivatives,” IEEE Trans. Pattern Anal. Machine Intell., Vol. PAMI-6. No. 1, pp. 5868, 1984 or other method, the edges can be obtained. With this method, a point of inflection on the edge part can be obtained with an accuracy of about one tenth times the pixel unit.

(B) The other is a technique that can cope with the case where there exists virtually no contrast between the inside of the pattern and the grounding. That is, for example, by a method disclosed in the literature [reference 2]: Cartan Steger, “An unbiased detector of curvilinear structures,” IEEE Trans. Pattern Anal. Machine Intell., Vol. 20, No. 2, February 1998, the edges are obtained. With this method, a peak of the edge can be obtained with an accuracy of about one-tenth times pixel unit. However, in this technique, the edge direction has only a value of 0 to 180 degrees. That is, the inside of the pattern cannot be specified.

In the case where there exists the contrast between the inside of the pattern and the grounding, the image may be processed by a differential filter (for example, Sobel filter or a band-pass filter) to generate an edge amplitude image, which may be used to obtain the edge by the aforesaid method. In this case, the inside of the pattern can be judged and the edge direction can be specified.

Since these methods are processing with the use of a rather large window, an accuracy of about one-tenth times the pixel unit can be obtained, and the edge direction can also be stable. This means that concatenating the edge positions for the linear approximation is not necessarily required.

At the edge detection of step S310, the edge amplitude and edge direction are obtained from the pattern image to-be-inspected for each pixel. The sharper the edge is, the larger the amplitude becomes. (A) When the image is such that the contrast exists between the inside of the pattern and the grounding, for example, by using the method of the above-described literature 1, the absolute value of the first derivative of the image can be set as the amplitude, and the zero cross point of the second derivative of the image can be taken as the edge position. On the other hand, (B) when the image is such that only the edge is bright, for example, by using the method of the above-described literature 2, a sign-inverted value (absolute value) of the second derivative of the image can be set as the amplitude, and the zero cross point of the first derivative of the image can be taken as the edge position. In either case, the edge can be obtained with a sub pixel accuracy. In the case of the image of (A), the direction of 0 to 360 degrees can be defined, whereas in the case of the image of (B), only the direction of 0 to 180 degrees can be defined. This is because in the image of (B), the inside of the pattern cannot be specified from local information.

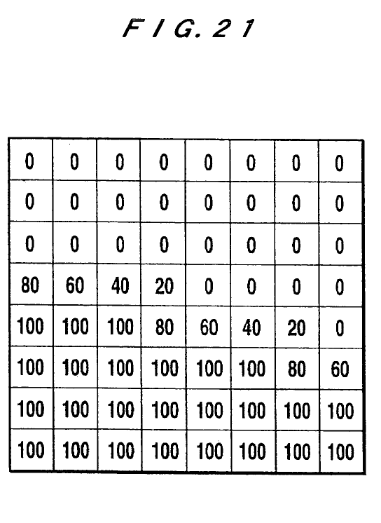

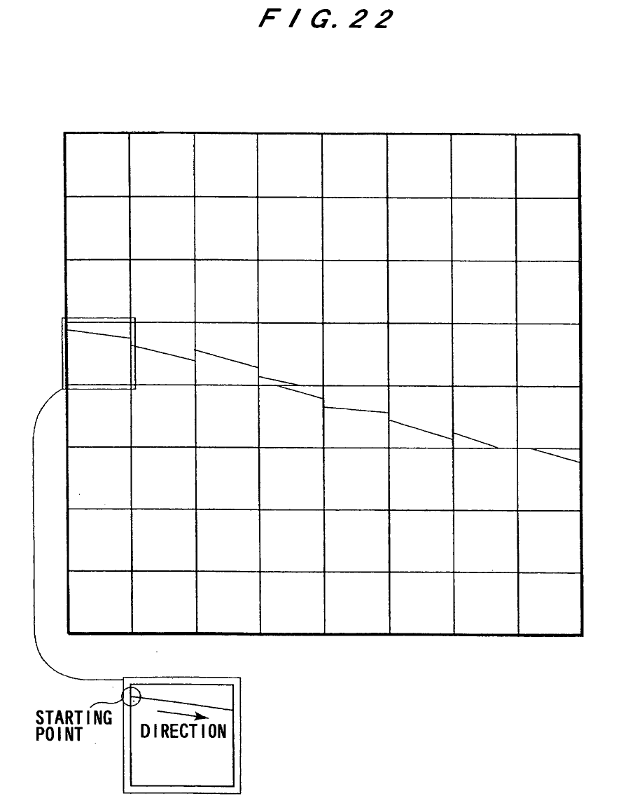

FIG. 21 is a diagram showing an example of (A) an image having the contrast between the inside of the pattern and the grounding (pattern image to-be-inspected) and FIG. 22 is a diagram showing the edges detected from the image of FIG. 21. In FIG. 21, the luminance value is shown for each pixel. As shown in FIG. 22, the edge is detected for each pixel, and information of a starting point (with a sub pixel accuracy), the direction (in 0 to 360 degrees), and the amplitude can be obtained for each pixel. As described above, the sharper the edge is, the larger the amplitude becomes.

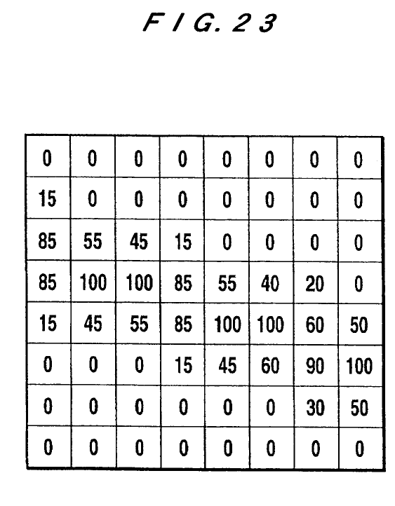

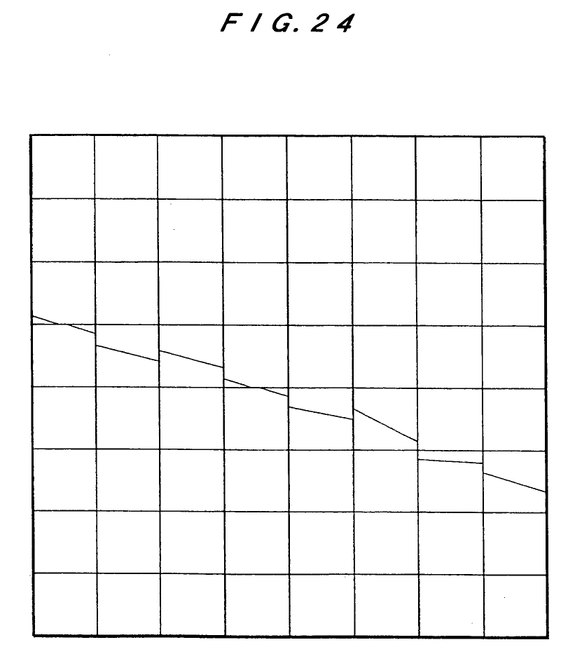

FIG. 23 is a diagram showing an example of (B) an image in which only the edge is bright (pattern image to-be-inspected) and FIG. 24 is a diagram showing the edges detected from the image of FIG. 23. In FIG. 23 also, the luminance value is shown for each pixel. Furthermore, as shown in FIG. 24, the edge is detected for each pixel, and information of the starting point (with a sub pixel accuracy), the direction (in 0 to 180 degrees), and the amplitude can be obtained for each pixel.

(Matching)

Next, the inspection unit 12 dilates the edges of the pattern image to-be-inspected to obtain dilated edges (step S312). In this embodiment, the edges are dilated by the allowable pattern deformation quantity that is allowed in terms of electrical characteristic. In this stage, the allowable pattern deformation quantity is a positive integer. If (R2) “limits of the negative side and the positive side of the allowable pattern deformation quantity” are different, this value is one that has a larger absolute value and is rounded into an integer. By dilating the edge by the allowable pattern deformation quantity, the matching can be conducted while allowing the shape difference that falls within an electrically allowable range.

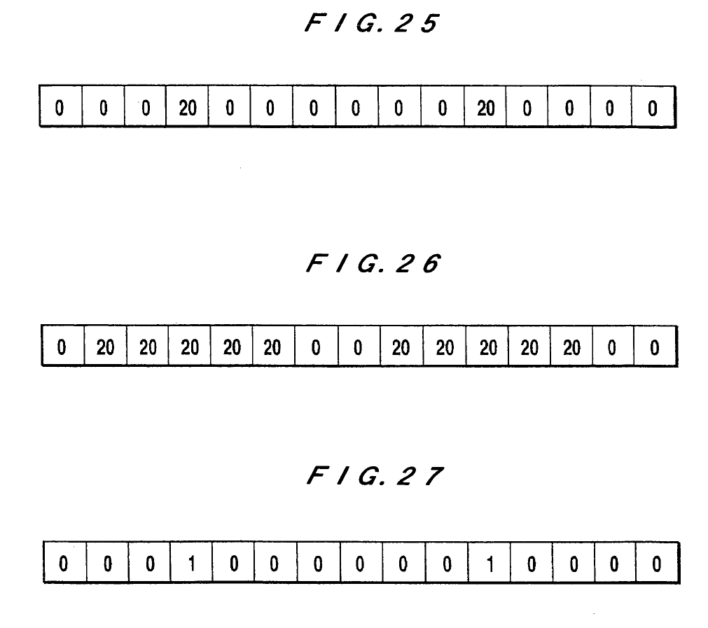

FIG. 25 is a diagram showing the edge amplitudes of the one-dimensional pattern image to-be-inspected and FIG. 26 is a diagram showing an example in which the edges of FIG. 25 are dilated. FIG. 25 and FIG. 26, for the sake of simple explanation, show the example of the case where the pattern image to-be-inspected is one-dimensional and the edge amplitude possessed by each pixel is a scalar value. When treating the deformation within the allowable pattern deformation quantity equally, the pattern image to-be-inspected is processed with a maximum value filter having a window which is twice as large as the allowable pattern deformation quantity. Here, the maximum filter is as follows: The maximum value among values possessed by neighboring pixels of the target pixel and within a window centered at the target pixel is obtained, and such maximum value is assumed to the value of the target pixel after the filter operation. In FIG. 26, the edges of FIG. 25 are dilated rightward and leftward by 2 pixels, respectively. This is an example for the case where the allowable pattern deformation quantity is two pixels.

On the other hand, assuming that the edges of the reference pattern are as in FIG. 27, if the evaluation value (degree) of the matching is obtained from FIG. 26 and FIG. 27, the evaluation value of the matching becomes the same both for the case where the pattern image to-be-inspected is located at the present position and for the case where the pattern image to-be-inspected is displaced rightward or leftward by one pixel or two pixels.

In order to avoid this, the edge should be dilated with weight given to the neighboring pixels as shown in FIG. 28. This way of giving weight signifies such matching that the smaller the allowable pattern deformation quantity is, the better the evaluation value becomes. In order to realize the dilation of FIG. 28, a smoothing filter consisting of 0.5, 0.75, 1.0, 0.75, and 0.5 coefficients may be used. In the case of FIG. 28, when the pattern image to be-inspected is displaced rightward or leftward even by one pixel, the evaluation value will decrease.

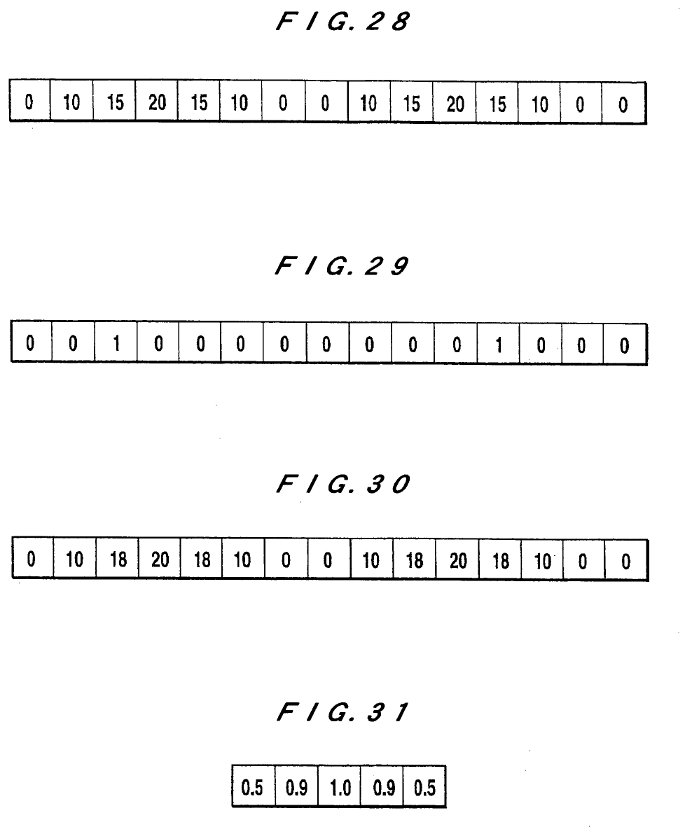

Here, as shown in FIG. 29, it is assumed that the edges of the reference pattern are wider than the present edges by two pixels. If the evaluation value is calculated from FIGS. 28 and 29, the same evaluation value is obtained both for the case where the pattern image to-be-inspected exists as it is and for the case where the pattern image is displaced rightward or leftward by one pixel.

All that is needed to circumvent this is only to dilate the edge with weight given as shown in FIG. 30. In order to realize the dilation of FIG. 30, a smoothing filter consisting of 0.5, 0.9, 1.0, 0.9, and 0.5 coefficients (FIG. 31) should be used. Coefficients of the smoothing filter should be obtained experimentally.

In light of the foregoing, the dilation as shown in FIG. 30 is desirable. However, from the point of view of the processing speed, crowdedness of the edges, etc., the dilation as shown in FIG. 26 or FIG. 28 may be used.

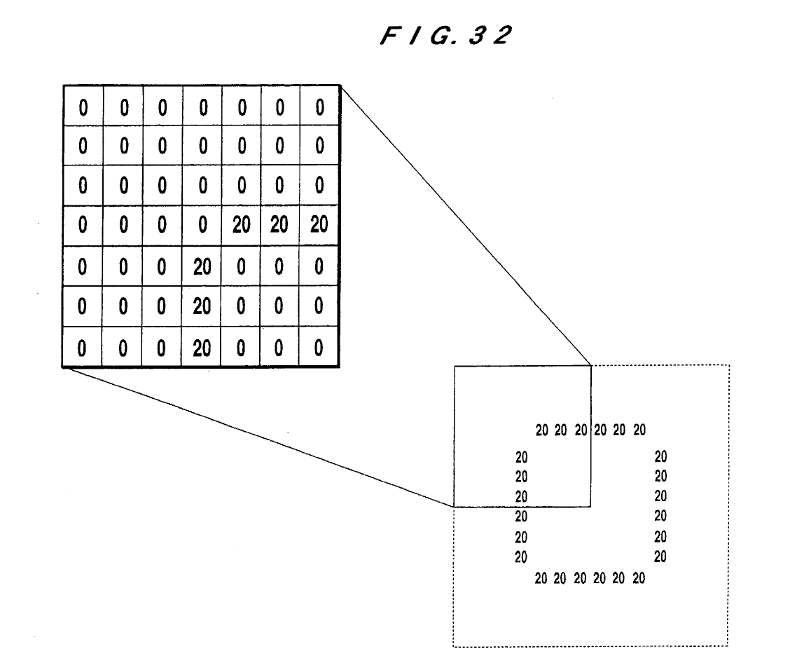

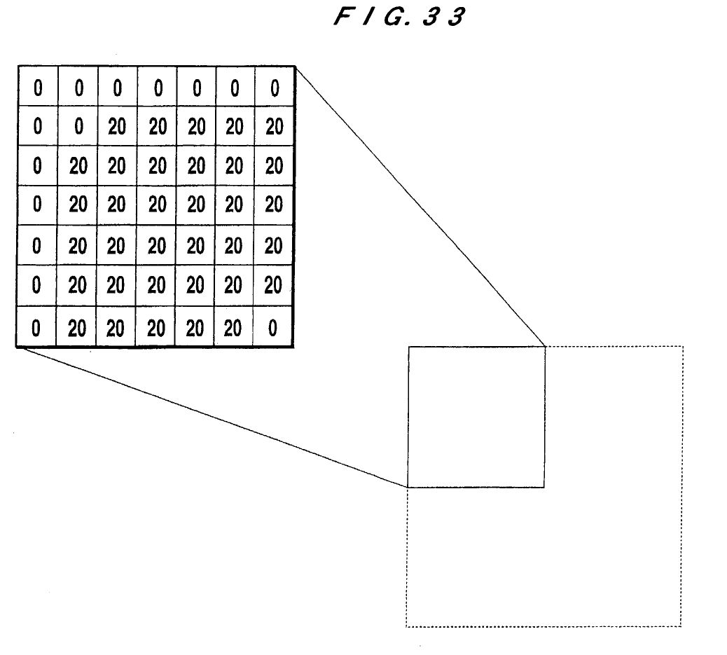

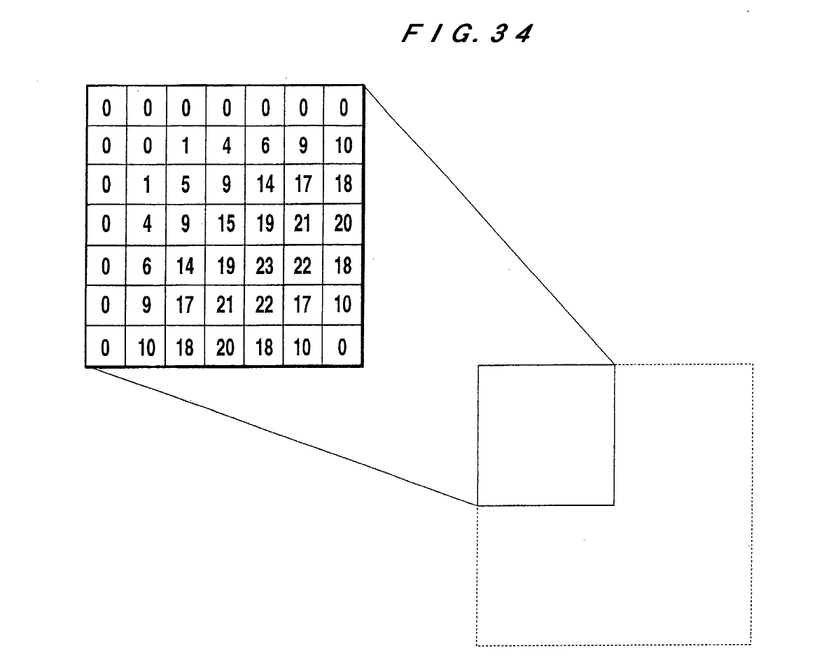

FIG. 32 is a diagram showing an example of the edge amplitudes of the two-dimensional pattern image to-be-inspected, and FIGS. 33 and 34 are diagrams showing examples in which the edges of FIG. 32 are dilated. In FIG. 32, the amplitude values are all zero except for pixels having an amplitude of 20. FIG. 33 shows a result for the case where the same dilation as that of FIG. 26 is conducted, and FIG. 34 shows a result for the case where the same dilation as that of FIG. 30 is conducted.

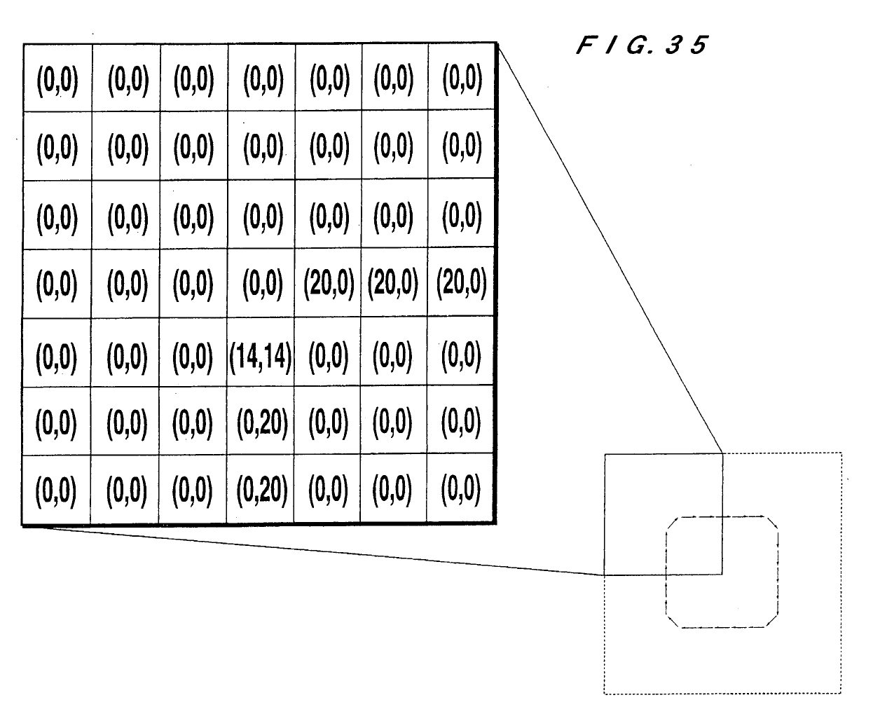

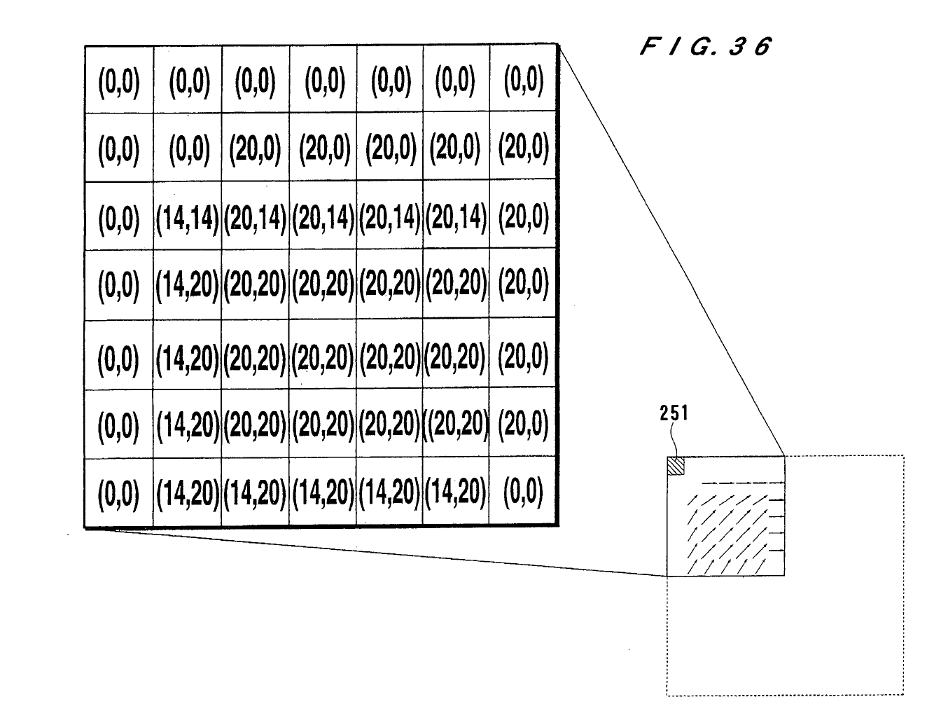

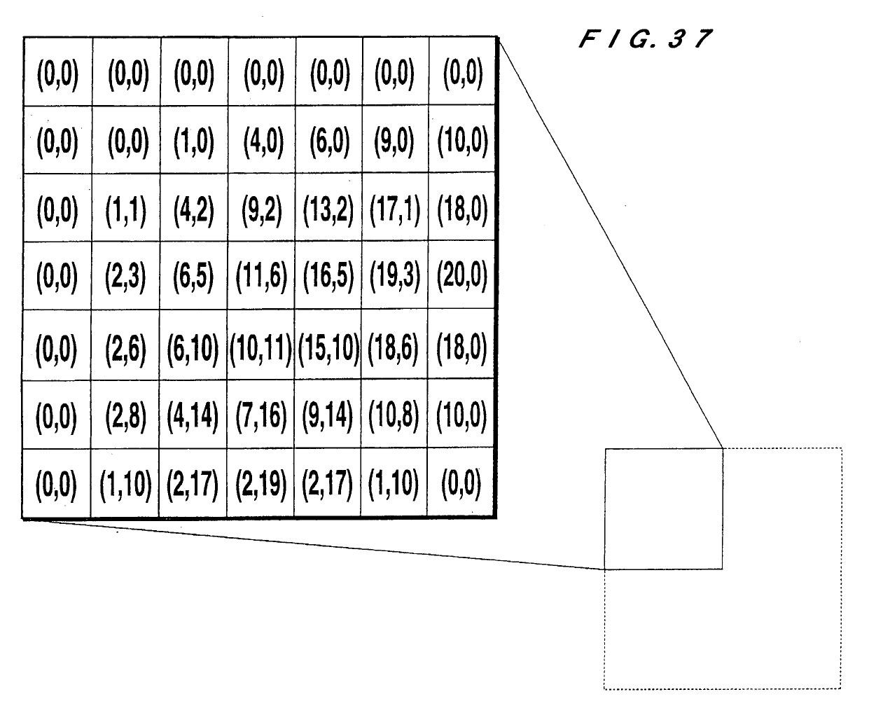

FIG. 35 is a diagram showing an example of the edge vectors of the two-dimensional pattern image to-be-inspected, and FIGS. 36 and 37 are diagrams showing examples in which the edge vectors of FIG. 35 are dilated. FIG. 36 shows a result for the case where the same dilation as that of FIG. 26 is conducted, and FIG. 37 shows a result for the case where the same dilation as that of FIG. 30 is conducted. The dilation is conducted for each x- and y-component separately.

The inspection unit 12 compares the dilated edges (edges formed by dilating the edge of the pattern image to be-inspected) with the edge of the reference pattern, and performs the matching between the pattern image to-be-inspected and the reference pattern, pixel by pixel (step S314).

Since in this embodiment, as will be described later, the matching is performed with a sub pixel accuracy, here, the matching is conducted pixel by pixel for the purpose of accelerating. FIG. 38 is a view showing FIG. 18 in units of pixel.

In the matching of this embodiment, the reference pattern is shifted with respect to the pattern image to-be-inspected vertically and horizontally in units of pixel to find a position where the evaluation value F₀ becomes the maximum, and such position is taken as a matching position (FIG. 39). In this embodiment, as in the following, a total sum of the amplitudes of the dilated edges in pixels where the edge of the reference pattern exists is taken as the evaluation value F₀.

$${F}_{0} ( xs , ys ) = {\sum }_{x = {X}_{Ea}}^{{X}_{Eb}} {\sum }_{y = {Y}_{Ea}}^{{Y}_{Eb}} \vert E ( x , y ) ‖ R ( x + xs , y + ys ) \vert \\ ( {X}_{Ra} - {X}_{Ea} \leq xs \leq {X}_{Rb} - {X}_{Eb} ) \\ ( {Y}_{Ra} - {Y}_{Ea} \leq ys \leq {Y}_{Rb} - {Y}_{Eb} )$$

Here, E (x, y) is an edge vector whose magnitude is equal to the amplitude of the dilated edge and whose direction is identical to the direction of the dilated edge. In pixels where no edge exists, the magnitude of E(x, y) is zero. R (x+xs, y+ys) is an edge vector whose direction is identical to the edge direction of the reference pattern, where the magnitude of R (x+xs, y+ys) is unity, i.e. 1 in the pixels where the edge exists, and zero in the pixels where no edge exists. Here, a vector (xs, ys) is the shift quantity S₁ of the edge of the reference pattern.

If, in the calculation of F₀, only the pixels whose R(x, y) is non-zero are stored, the calculation can be performed at a high speed and the memory area to be used can be reduced. If truncation of the high-speed calculation used in the sequential similarity detection algorithm (SSDA) is employed with the use of the total sum of the pixel amplitude values as an evaluation function, the calculation can be speeded up even further.

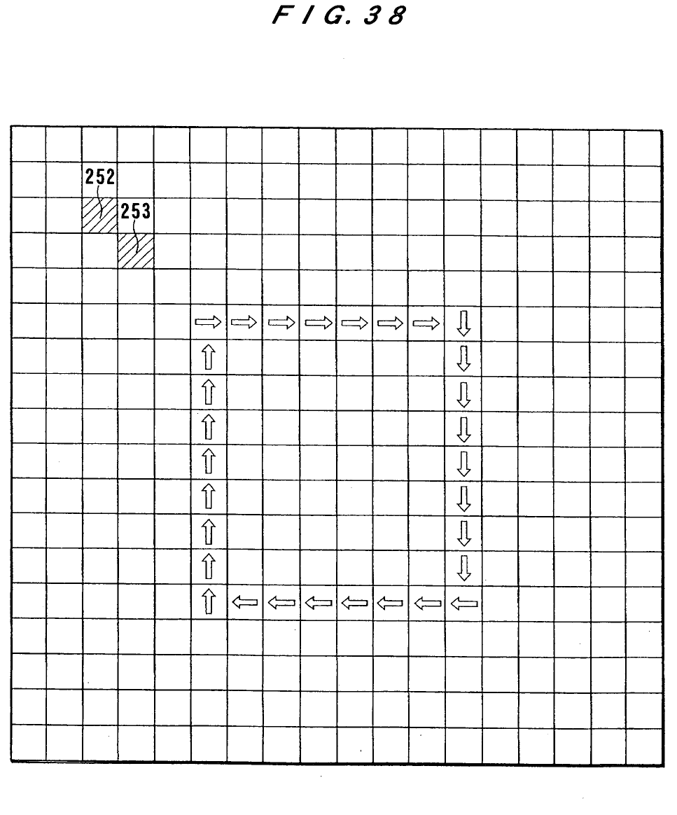

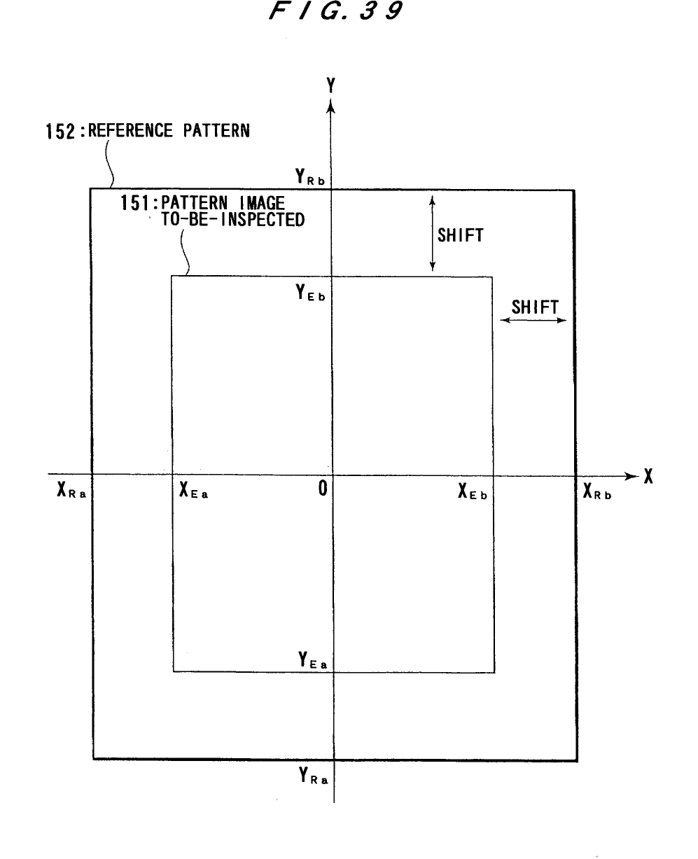

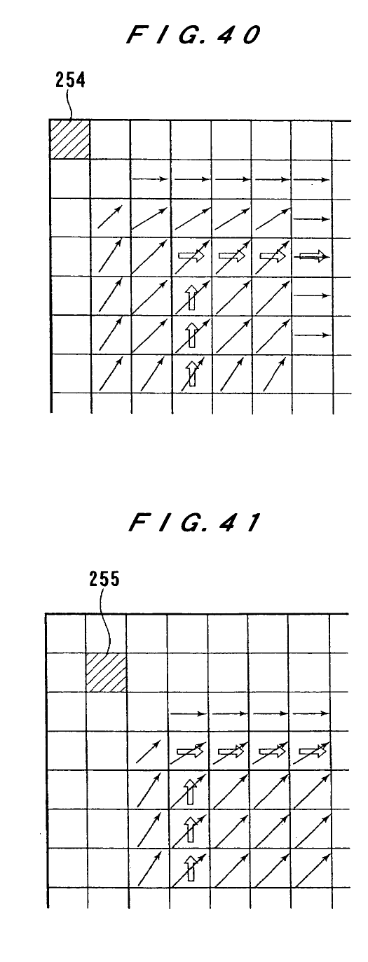

FIGS. 40 and 41 are diagrams which are made by superimposing FIG. 36 and FIG. 38. In FIG. 40, a pixel 254 corresponds to a pixel 251 of FIG. 36 and also to a pixel 252 of FIG. 38. In FIG. 41, the superimposing is conducted with the pattern image to-be-inspected shifted rightward by one pixel and downward by one pixel from the state of FIG. 40. Therefore, a pixel 255 corresponds to the pixel 251 of FIG. 36 and also to the pixel 253 of FIG. 38. When the evaluation value F₀ is used, the larger the degree of overlapping of the pixels where the edge exists, the higher the evaluation value becomes. In the case where the evaluation value F₀ is used, the dilation processing as shown in FIGS. 32 through 34 should be conducted. In addition, the evaluation value F₀ can be applied to both images of (A) and (B).

In this embodiment, the aforesaid evaluation value F₀ is used, but other evaluation value can also be used. For example, in the case of the image having the contrast between the inside of the pattern and the grounding (case A), it may be conceivable that the following evaluation value Fₐ is used.

$${F}_{a} ( xs , ys ) = {\sum }_{x = {X}_{Ea}}^{{X}_{Eb}} {\sum }_{y = {Y}_{Ea}}^{{Y}_{Eb}} E ( x , y ) \cdot R ( x + xs , y + ys )$$

$$( {X}_{Ra} - {X}_{Ea} \leq xs \leq {X}_{Rb} - {X}_{Eb} )$$

$$( {Y}_{Ra} - {Y}_{Ea} \leq ys \leq {Y}_{Rb} - {Y}_{Eb} )$$

Moreover, for example, in the case of (B) the image in which only edges are bright, it may be conceivable that the following evaluation value F_{b} is used.

$${F}_{b} ( xs , ys ) = {\sum }_{x = {X}_{Ea}}^{{X}_{Eb}} {\sum }_{y = {Y}_{Ea}}^{{Y}_{Eb}} \vert E ( x , y ) \cdot R ( x + xs , y + ys ) \vert$$

$$( {X}_{Ra} - {X}_{Ea} \leq xs \leq {X}_{Rb} - {X}_{Eb} )$$

$$( {Y}_{Ra} - {Y}_{Ea} \leq ys \leq {Y}_{Rb} - {Y}_{Eb} )$$

In the case where the evaluation value Fₐ or F_{b} is used, the dilation processing as shown in FIGS. 35 through 37 should be conducted. However, when the dilation as shown in FIG. 36 is conducted, the dilation is conducted for both the maximum value of the positive values and the maximum value of the negative values, and one that gives a larger total sum in calculating the inner products is selected.

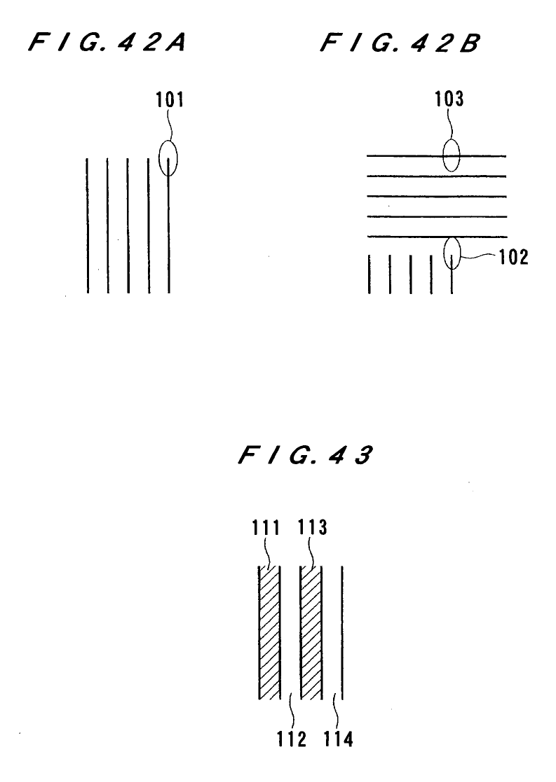

If the evaluation value F₀ and the evaluation values Fₐ, F_{b} are compared with each other, the evaluation value F₀ suits for the high-speed processing because the data is scalar. On the other hand, the evaluation values Fₐ and F_{b} are effective, for example, in the case as shown in FIGS. 42A and 42B. That is, when the evaluation values Fₐ and F_{b} are used, since the inner product between the edge vector of vertical line part of the reference pattern (FIG. 42A) and the edge vector of the horizontal line part of the pattern image to-be-inspected (FIG. 42B) becomes close to zero, a part 101 and a part 102 can be matched successfully. On the contrary, when the evaluation value F₀ is used, since only the amplitude is used to make the judgment regardless of the direction, the part 101 and a part 103 are likely to be matched erroneously.

Next, if the evaluation values Fₐ and F_{b} are compared with each other, for example, when the value Fₐ is used in the case where the spacing between wiring 111, 113 and the spacing between the grounding 112, 114 are identical as shown in FIG. 43, the value Fₐ can obtain a more preferable result than the value F_{b}, because distinction between the wiring and the grounding is clear.

In this embodiment, the edges of the pattern image to-be-inspected are dilated and the matching is conducted. Alternatively, the edges of the reference pattern may be dilated to conduct the matching.

Further, the matching may be conducted in such a manner that the weighting is altered depending on the edge position of the reference pattern. This is carried out by the following procedure.

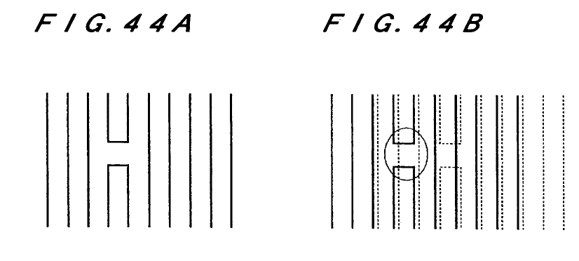

FIG. 44A is a diagram showing an example of the reference pattern, and FIG. 44B is a diagram showing an example of the reference pattern (solid lines) and the pattern image to-be-inspected (dotted lines). The reference pattern shown in FIG. 44A is a periodic pattern, which has an interstice at one position. When the matching between such reference pattern and the pattern image to-be-inspected is conducted, even if both the patterns are different as shown in FIG. 44B, most part thereof except the interstice part coincides with each other, and hence this matching gives a high evaluation value erroneously. To avoid this, it may be conceivable that a large weighting is given to this interstice part, so that the matching evaluation value will decrease largely when the interstice of the pattern image to-be-inspected and the interstice of the reference pattern do not coincide with each other.

The following is the procedure of setting the weightings: First, the period of the pattern is obtained by the autocorrelation method. Next, by comparing the original pattern and the pattern shifted by one period, a feature that exists in a certain part of the original pattern, but does not exist in the pattern shifted by one period is obtained. Then, the pattern thus obtained is recognized as a unique pattern and a contribution (weighting) of the unique pattern to the matching is made larger than that of other patterns. To express the degree of contribution, an empirical value (unity (1) or more) is used for the amplitude of the reference pattern. For this value, a constant value, a value defined as a constant value divided by a ratio of the unique pattern to all the patterns, and the like are effective.

When the matching is conducted and the shift quantity S₁=(xs, ys) at which the evaluation value takes the maximum is obtained, the reference pattern is shifted by the amount of S₁. The subsequent processing is conducted while this shift is being maintained.

The shift quantity S₁ can be outputted to the display device 5 and the printer 6 as the inspection result.

After the matching is completed, the pattern image to-be-inspected is binarized. The binarization is conducted by judging whether the amplitude of each edge is present or absent with the use of one of the edge detection parameters in the recipe (threshold value). Alternatively, there is also a method (p tile method) in which the edge image of the pattern image to-be-inspected is binarized so that the number of pixels corresponding to the edge of the reference pattern×p (p: normally about 0.9 to 1.1) becomes unity, i.e. 1. The above-described threshold value or the value p should be set as the parameter of (R3).

(The First Inspection)

Next, the inspection unit 12 performs the first inspection. Specifically, calculation of the pattern deformation quantity and the defect detection are conducted.

The inspection unit 12 carries out the correspondence between the edge of the pattern image to-be-inspected and the edge of the reference pattern (step S318).

The edge position is treated with a sub pixel accuracy. Therefore, the distance between the two edges can also be obtained with a sub pixel accuracy. The direction is determined as a value in a range of 0 to 360 degrees with the right direction being set to, for example, 0 degree.

For each edge pixel of the reference pattern, the edge pixels of the pattern image to-be-inspected located within the distance of the allowable pattern deformation quantity equal to (R2), are searched. Then, among the detected edges, one edge whose directional difference from the edge of the reference pattern falls within (R2) “a limit of the allowable directional difference of the edge” is determined as the corresponding edge within the allowable deformation. That is, in this embodiment, the correspondence-assumption is conducted in consideration of the distance between the edge of the pattern image to-be-inspected and the edge of the reference pattern that have undergone the matching, and the directions of both edges. A vector d (x, y) between the two edges that have been assumed to be in the correspondence to each other can be used to obtain the pattern deformation quantity.

In addition, if there exists a plurality of candidates for the correspondence-assumption, a candidate whose distance is small and whose directional difference is small is prioritized for the correspondence-assumption.

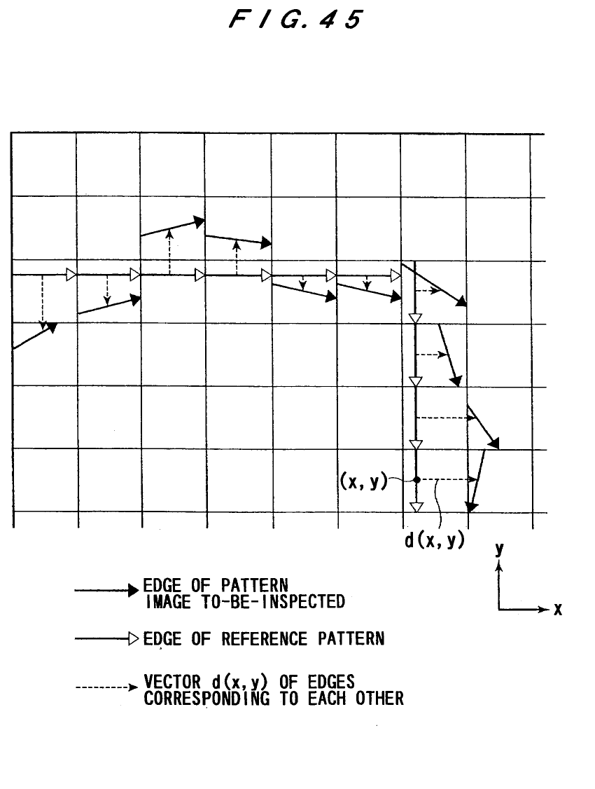

FIG. 45 is a diagram showing an example of the correspondence-assumption between the edge of the pattern image to-be-inspected and the edge of the reference pattern. In FIG. 45, each edge is indicated by an arrow to show its direction. In the example of FIG. 45, the correspondence-assumption is conducted for each pixel that contains the edge of the reference pattern by finding the edge of the pattern image to-be-inspected in a direction perpendicular to the edge direction from the center of the edge of the reference pattern. If such an edge of the pattern image to be-inspected that the distance is within the allowable pattern deformation quantity and the directional difference is within the allowable directional difference of the edge is found, the correspondence between both the edges is assumed. In FIG. 45, the vector d(x, y) between the two edges that have been assumed to be in the correspondence to each other is shown for reference.

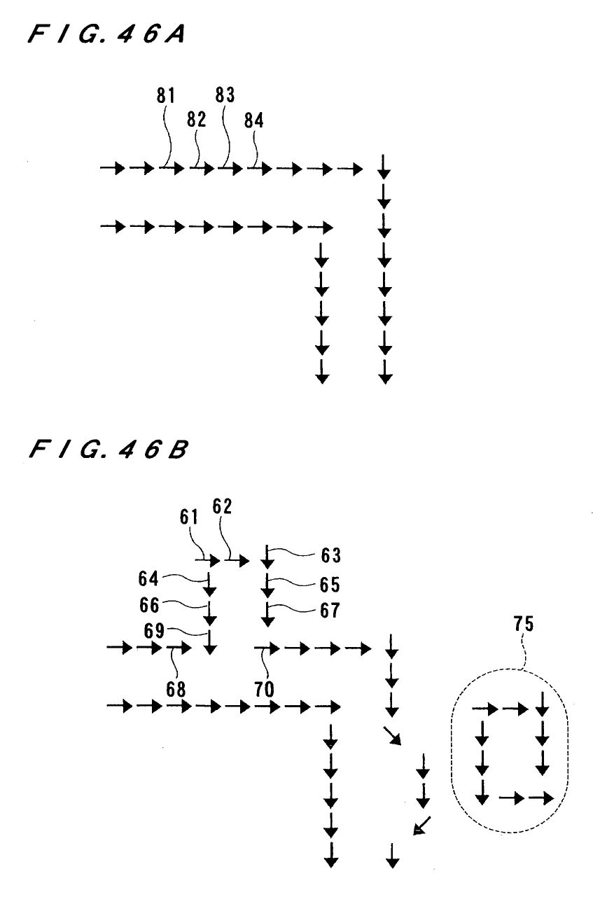

FIG. 46A is a diagram showing an example of the edge of the reference pattern, and FIG. 46B is a diagram showing an example of the edge of the pattern image to-be-inspected corresponding to the reference pattern of FIG. 46A. The correspondence-assumption of both the edges will be described with reference to FIGS. 46A and 46B. In this example, the allowable pattern deformation quantity is set to one pixel, and the allowable directional difference of the edge is set to 60 degrees. For example, if an edge of the pattern image to-be-inspected corresponding to an edge 81 of the reference pattern is searched, because an edge 68 is within the distance of the allowable pattern deformation quantity from the edge 81 and its directional difference is not more than the allowable directional difference of the edge, the edge 68 is determined as the corresponding edge to the edge 81. Regarding an edge 84 of the reference pattern also, an edge 70 is determined as the corresponding edge of the pattern image to-be-inspected. At this time, regarding an edge 82 of the reference pattern, an edge 61 is not within the distance of the allowable pattern deformation quantity. An edge 64 is not within the distance of the allowable pattern deformation quantity, and the directional difference is larger than the allowable directional difference of the edge. Although edges 66 and 69 are within the distance of the allowable pattern deformation quantity, their directional differences are larger than the allowable directional difference of the edge. Therefore, an edge corresponding to the edge 82 cannot be found. Similarly, an edge corresponding to an edge 83 cannot be found.

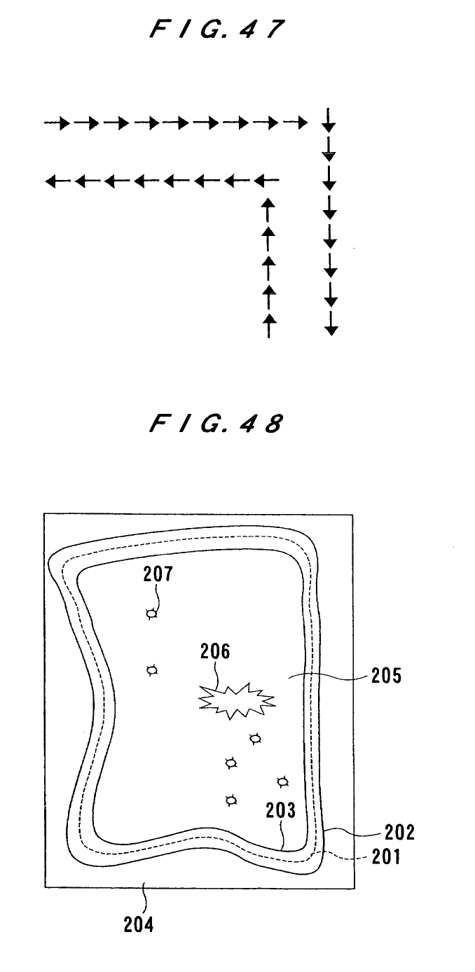

In addition, FIGS. 46A and 46B exemplify a method in which the inside and the outside of the pattern are not distinguished and the direction is specified to have a value only in a range of 0 to 180 degrees. However, a method in which the inside and the outside of the pattern are distinguished can be used. For example, if the edge direction is determined so that the inside of the pattern is always located at the right of the edge, the pattern image of FIG. 46A becomes the state shown in FIG. 47, and hence the correspondence-assumption can be executed more exactly.

Next, the inspection unit 12 conducts the defect detection (step S320). When the defect is detected, defect information (here, information of the defect position and the size and its image) is outputted to the defect-class determination unit 14 (steps S322, S324).

The defect-class determination unit 14 judges the defect class based on the defect information and information of the defect-class reference database 23 (step S326). That is, the feature quantities are obtained from the given image and are collated with the feature quantities of the images stored in the defect-class reference image database to judge the defect class. The defect-class determination unit 14 outputs the defect information and the defect class to the display device 5 and the printer 6 through the output unit 13 (step S328). Here, the defect-class reference database 23 is a database in which the acquired images have been registered for respective defect classes.

As a method for determining the defective area, it is conceivable to employ a method for determining a defective area (determination method A) in which an area is determined from the edges of the pattern image to-be-inspected which have not obtained the correspondence to the edges of the reference pattern and this area is determined as the defective area. This method is effective in detecting the defect having distinct edges. However, since this method is poor in detecting the defect having indistinct edges, in such a case, a proper method is a method for determining a defective area (determination method B) in which an area is determined from the edges of the pattern image to-be-inspected that have been assumed to be in the correspondence to the edges of the reference pattern, and a part of that area whose distribution of the pixel luminance value is non-uniform is determined as the defective area. That is, the defect is determined from abnormality of the luminance value distribution.

In the determination method A, the pixels containing the edges of the pattern image to-be-inspected that have not obtained the correspondence to the edges of the reference pattern (for example, edges 61 to 67 and edges 69 to 75 of FIG. 46B) are determined as the defect. The inspection unit 12 dilates these pixels to effect joining of the pixels. As processing for dilating such a bit map (binarized image), the processing called morphology is known. Next, the pixels that have been joined to form one block area are determined as one clustered area through a labeling processing. Here, the labeling processing is defined as a method in which a group of the joined pixels is formed by writing the same value on the pixels that are being joined at four neighborhoods or eight neighborhoods thereof. By giving a different value to the pixels that are not joined, the group of the joined pixels can be distinguished from other pixels. When the pixels have been isolated as this clustered area, this area is judged as an alien substance (foreign object) and its shape (outer form) is determined. The inside pixels surrounded by the shape (outer form) are painted out by the paint processing. These pixels are regarded as the defects and the centroid and size of the defects are calculated.

The edge used herein is an edge obtained according to (Scan-1) process through (Scan-3) process.

In the determination method B, the edges of the pattern image to-be-inspected that have been assumed to be in the correspondence to the edges of the reference pattern are joined to form an area. In its inside area and in its outside area, respectively, a part excluding the boundary (edge) is obtained as the clustered pixels. For both the inside area and the outside area of the clustered pixels, the pixel luminance values are obtained from the pattern image to-be-inspected that has been initially obtained. If there is no defect, these values can be expected to constitute a normal distribution. That is, by applying a quality control method, defect pixels can be detected. If these pixels are normal, the variation in the luminance is expected to be small both in the inside area and in the outside area. Therefore, an area whose luminance distribution is non-uniform among the aforesaid areas in the pattern image to-be-inspected can be detected, and such area can be determined as the defective area. The defect pixels thus obtained are determined as the clustered pixels and the centroid and size thereof are calculated.

According to the unidirectional scan of (Scan-1) process and the alternate scan of (Scan-2) process, the above process is performed on a single image to recognize the area as a defective area. According to the bidirectional scan of (Scan-3) process, the above process is performed on two images, and an area where an obtained defective area is superposed is recognized as a defective area. The superposing process usually comprises an ORing process, which may be combined with an ANDing process for more strictly detecting defects.

FIG. 48 is a diagram showing an example of the pattern image to-be-inspected. A broken line 201 shows the edge of the pattern image to-be-inspected. Solid lines 202, 203 on both sides of the broken line 201 are segment lines which are formed by dilating the edges by a predetermined width, and a part surrounded by the solid lines 202, 203 is determined as the edge area. The luminance values of a grounding 204 and an inside 205 of the pattern roughly constitute a normal distribution.

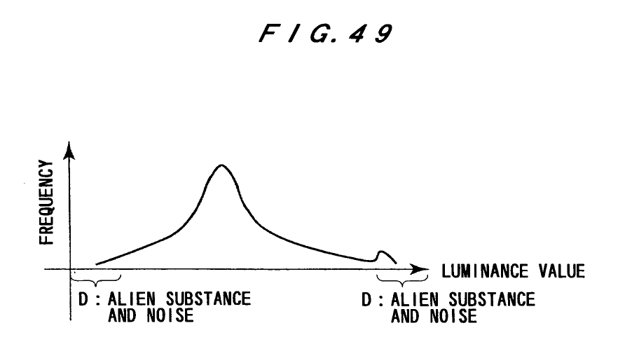

As shown in FIG. 49, a part D located beyond the ±3σ regions of the distribution is very likely to be the alien substance (foreign object). Although the part D also contains a noise, the noise exists in the area in a relatively uniform manner, whereas the alien substance exists as being clustered. A binarized map in which any pixel having a luminance value equal to that of D is binarized to unity, i.e. 1 and a pixel having other luminance value is binarized to zero is formed. The clustered pixels having a luminance of unity (1) whose size is not more than a specified size (for example, 2×2 pixels) is erased (for example, the clustered pixels 207 of FIG. 48 being erased). A median filter and a morphology filter can be used. A window size of these filters should be an empirical value that is determined in consideration of the size of the alien substance which should be detected. The clustered pixels having a luminance of unity (for example, the clustered pixels 206 in FIG. 48) are regarded as the alien substance.

The defect-class determination unit 14 can perform automatic classification of the defect classes as follows: That is, the geometrical feature quantities of the clustered pixels that have been determined as defects are obtained. Based on these, a shape feature such as being circular, being elongated, etc. can be found, and if the shape is circular, the defect is judged to be the alien substance, if the shape is elongated, the defect is judged to be a scratch, or the like. The pixels that have been judged to be defects are classified into three classifications: pixel inside the pattern; pixel outside the pattern; and pixel on the boundary. For each classification, the feature quantities of the pixels are obtained by using the pixel luminance values of the pattern image to-be-inspected, which have been initially obtained. If the pixel is judged to be the alien substance based on the feature quantities obtained at this stage (for example, the geometrical feature quantities), whether the alien substance is a metal piece or organic material (for example, human dirt) or the like can be judged. That is, the kind of defect can be judged as follows: If the alien substance is a metal, it looks bright because of its strong reflection; and if it is the organic material, it looks dark. Further, in the case where the alien substance exists inside the pattern, when the pixels judged to be the alien substance show large variation in the luminance, it is judged that the alien substance concerned is very likely to exist on the pattern; when such pixels show small variation in the luminance, it is judged that the alien substance concerned is very likely to exist beneath the pattern. This is difficult processing for the conventional die-to-die method. The present method uses these feature quantities to judge the defect class by a well-known classification method. As the classification method, a method in which the defect class is judged by comparing the defect with the defect-class reference image database using a k nearest neighbor method is effective.

Such defect-class automatic classification is a method based on a conventionally applied optical method, namely, the ADC (Automatic Defect Classification) of the SEM method. According to the method of the present invention that uses the design data, distinction between the inside and the outside of the pattern can be conducted clearly, and hence the feature quantities for each part are found correctly, and accuracy of the classification is improved.

Next, the inspection unit 12 obtains the pattern deformation quantity from the relation between the edge of the pattern image to-be-inspected and the edge of the reference pattern that have been assumed to be in the correspondence to each other (step S330). The pattern deformation quantity is obtained for a part where a defect has not been detected as a result of the defect detection. Then, the pattern deformation quantity is outputted to the display device 5 and the printer 6 through the output unit 13 (step S332).

Two pattern deformation quantities can be considered: One is a pattern deformation quantity obtained from the whole image, and the other is a pattern deformation quantity obtained for each attribute of the pattern.

As the pattern deformation quantity obtained from the whole image, for example, a displacement quantity, a magnification variation quantity, and a dilation quantity of the line width may be considered.

The displacement quantity can be calculated as an average value of the vectors d(x, y) between the two edges that have been assumed to be in the correspondence to each other. This value becomes the shift quantity (correction quantity) S₂ with a sub pixel accuracy of S₁=(xs, ys). By further shifting the reference pattern which has been shifted through the matching by pixel increments (or decrements) on the basis of this shift quantity (correction quantity) S₂, by the correction quantity, the matching can be achieved with a sub pixel accuracy.

In order to calculate the magnification variation quantity in the x-direction, the x-components of the vectors d(x, y) concerning the reference pattern in a longitudinal direction are approximated with the regression line D(x) to find a regression line. Then, the gradient of the regression line is taken as the magnification variation quantity in the x-direction. The procedure is the same for the magnification variation quantity in the y-direction.

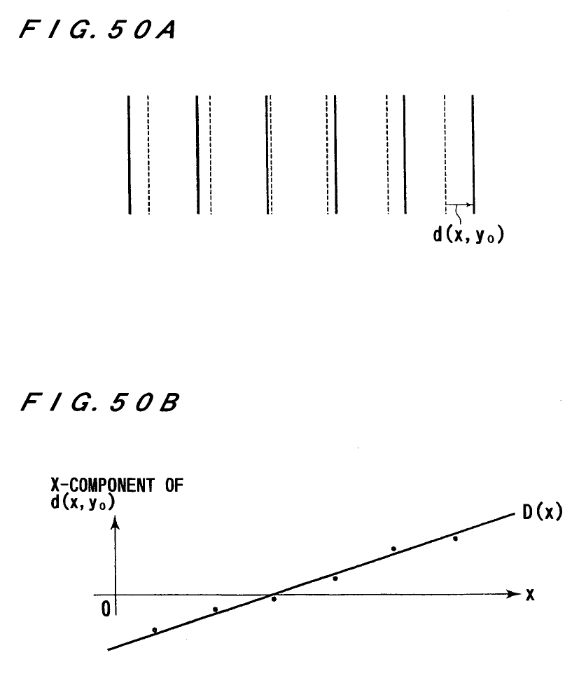

FIG. 50A is a diagram showing an example of the edges of the reference pattern (broken lines) and the edges of the pattern image to-be-inspected (solid lines), and FIG. 50B is a diagram showing an example in which the x-components of the vectors d(x, y₀) between the two edges at y=y₀ shown in FIG. 50A are approximated with the regression line D(x). When the x-components of the vectors d(x, y₀) are approximated with the regression line D(x)=ax+b, the gradient ‘a’ corresponds to the magnification variation quantity. In the example of FIG. 50A, it is found that the pattern of the pattern image to-be-inspected is larger than the reference pattern as a whole.

FIG. 51A is a diagram showing another example of the edges of the reference pattern (broken lines) and the edges of the pattern image to-be-inspected (solid lines), and FIG. 51B is a diagram showing an example in which the x-components of the vectors d(x, y₀) between the two edges at y=y₀ shown in FIG. 51A are approximated with the regression line D(x). In the example of FIG. 51A, in addition to the pattern of the pattern image to-be-inspected being larger than the reference pattern as a whole, the line width is dilated. In FIG. 51A, the lines (wiring) 121, 122, and 123 of the reference pattern correspond to the lines 124, 125, and 126 of the pattern image to-be-inspected, respectively.

The dilation quantity of the line width in the x-direction can be obtained, for example, by calculating the average value of sign(x, y₀)×{x-component of d(x, y₀)−D(x)}. Here, sign (x, y₀) takes a value of −1 when (x, y₀) is positioned at the left end of the line, and takes a value of +1 when (x, y₀) is positioned at the right end of the line. In addition, if the variance of sign(x, y₀)×{x-component of d(x, y₀)−D (x)} is calculated with respect to the dilation quantity of the line width, a degree for the variation in the line width can be obtained.

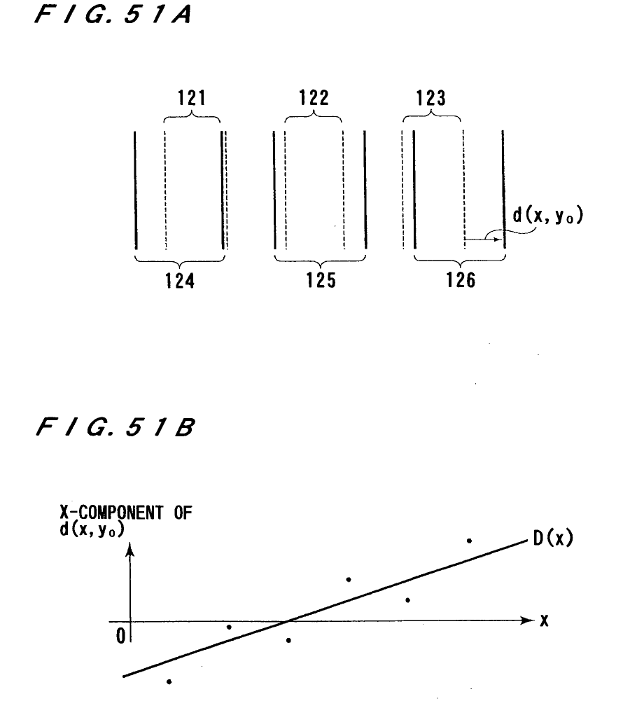

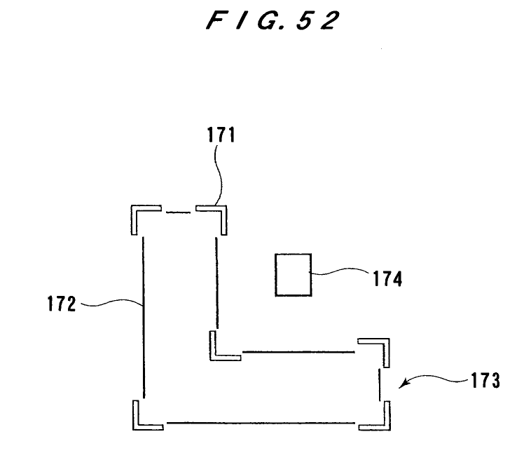

Next, the pattern deformation quantity that can be obtained for each of pattern attributes will be described. As pattern attributes, a corner 171, a long wiring 172, a top end 173, an isolated pattern 174, etc. can be considered (FIG. 52). As the pattern deformation quantities concerning the pattern attributes, for example, the followings can be considered: the above displacement quantity; the magnification variation quantity; and the dilation quantity of the line width; in addition, the deformation quantities of the feature quantities such as the area, the length of periphery, the circularity, the moment, and the radius of curvature.

The attribute information of the pattern can be automatically added to the reference pattern. However, the addition of the attribute information can be also performed manually. A rule for adding (extracting) the attribute information of the pattern is set as (R4) when the recipe is formed.

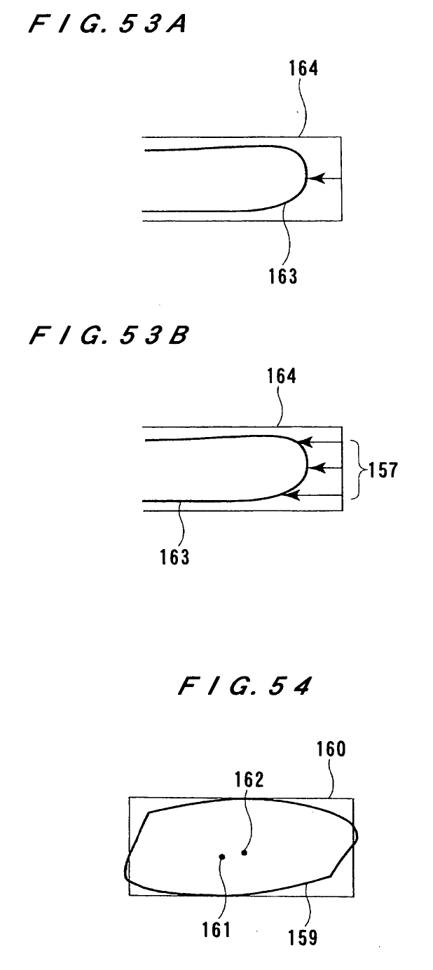

FIG. 53A is a diagram showing the displacement quantity of the top end. As shown in FIG. 53A, the displacement quantity of the top end is the distance from an edge 164 of the reference pattern to an edge 163 of the pattern image to-be-inspected (in a direction perpendicular to the edge of the reference pattern). As the displacement quantity of the top end, for example, the distance between the closest point to the edge 164 of the reference pattern in the edge 163 of the pattern image to-be-inspected and the edge 164 of the reference pattern can be measured.

Alternatively, as shown in FIG. 53B, any of the average value, the maximum value, the minimum value, the median, and the standard deviation of the distances of a section 157 having an arbitrary width that are measured a plurality of times may be used for the displacement quantity of the top end.

In FIGS. 53A and 53B, the displacement quantity of the top end has been described. However, with respect to the long wiring, the corner, the connection part between the attributes, and the like, the displacement quantity can be measured in the same manner. Moreover, for example, as for the corner, the displacement quantity in a direction at an angle of half of the corner's angle or a specified angle can be measured.

FIG. 54 is a diagram showing the displacement quantity of the centroid of the isolated pattern. The displacement quantity of the centroid is defined as the displacement quantity between a centroid 162 of an edge 160 of the reference pattern (which forms the isolated pattern) and a centroid 161 of an edge 159 of the pattern image to be-inspected (which forms the isolated pattern).

Moreover, it may be conceivable that, in FIG. 54, the deformation quantities of the feature quantities of the isolated pattern (area, length of periphery, the degree of circularity, moment, etc.) are measured. That is, it may be conceivable that the difference between the feature quantity of the edge 160 of the reference pattern and the feature quantity of the edge 159 of the pattern image to-be-inspected is measured.

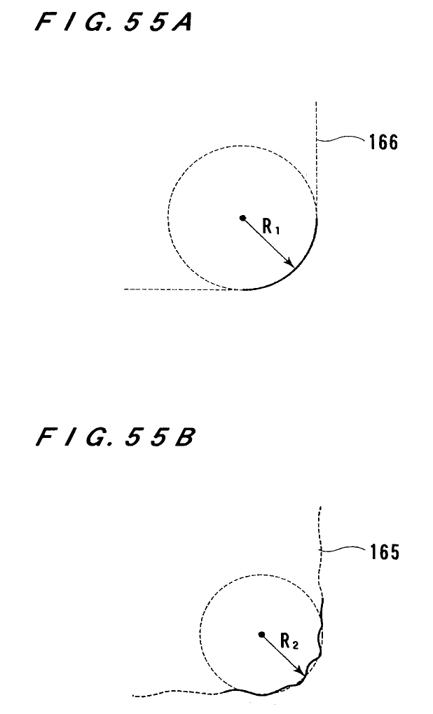

FIG. 55A is a diagram showing an example of the corner of an edge of the reference pattern, and FIG. 55B is a diagram showing an example of the corner of the edge of the pattern image to-be-inspected. The corner of an edge 166 of the reference pattern shown in FIG. 55A is subject to rounding processing. As the radius of curvature of the corner, for example, a major axis or minor axis of an ellipse, or a radius of a circle that is obtained when the curve of the corner is approximated with the ellipse or the circle by the least-squares method can be used. By obtaining the radius of curvature of the corner in the edge 166 of the reference pattern and the radius of curvature of the corner in an edge 165 of the pattern image to-be-inspected, the deformation quantity of the radius of curvature of the corner can be found.

The foregoing inspection may be performed one position by one position. Alternatively, the inspection may be performed simultaneously (in one-time imaging) for a plurality of positions within one imaging region (within a field of view).

The inspection item is selected according to (R1) “Pattern deformation quantity to calculate” of the above-described recipe items.

There are several kinds of extraction rules (the above-described (R4)) for the pattern attributes, and several examples will be described with reference to FIG. 52. The corner is extracted as a feature positioned in the vicinity of connecting points where two pairs of two lines connect with each other at a predetermined angle (90 degrees, 270 degrees, etc.). The long wiring is extracted as two parallel line segments having a spacing equal to the line width and having a length equal to or longer than a predetermined length. The top end is extracted as a part of a line segment having a length equal to the line width and having both ends with which other line segment having a length equal to or longer than a predetermined length comes in contact at an angle of 90 degrees. The isolated pattern is extracted as a closed figure having an area equal to or smaller than a predetermined area.

(The Second Edge Detection)

The inspection unit 12 detects the edge again from the pattern image to-be-inspected with respect to a part where no defect has been detected as a result of the defect detection (step S334).

This edge detection of the pattern image to-be-inspected is conducted by obtaining a profile on the pattern image to-be-inspected based on the second reference pattern. Here, as the second reference pattern, the reference pattern in the case where the position of point Q in FIG. 60 is regarded as the edge is used. On the contrary, as the first reference pattern, for example, for the image in which “only the edge is bright” as described above in (B), the reference pattern in which the position of point P is regarded as the edge is used. Therefore, the second reference pattern generally differs from the first reference pattern.

Before conducting the edge detection of the pattern image to-be-inspected, the second reference pattern is shifted by the above-described shift quantity S₁+S₂. Any subsequent processing is conducted in such a state that this shift is maintained.

In order to determine the edge position from the profile, various methods such as a threshold method or a linear approximation method have been disclosed. In the present embodiment, the threshold method is used and the measurement of the line width that is conducted in the CD-SEM is applied to two-dimensional patterns (pattern image to-be-inspected). However, if the threshold method is replaced with other method such as the linear approximation method, the processing can be made similarly. Here, the linear approximation method is a method in which the profile is approximated with lines and an intersection is used to specify the edge position.

Two kinds of methods are conceivable to detect the edge. One is a method in which the directions and the positions for taking the profiles are set beforehand with respect to the second reference pattern.

In this embodiment, in the case where the profile acquisition sections are set beforehand, it is done when forming the recipe as described above. In this case, (R6) “a flag for indicating whether or not the profile acquisition sections are set to be variable and to be determined during measurement” of the above-described recipe item is off, and hence the profile acquisition sections are set beforehand with respect to the second reference pattern.

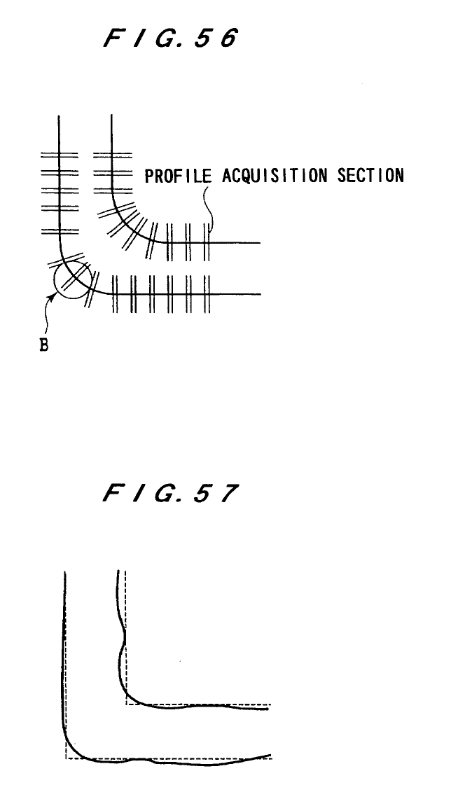

The section in which the profile is acquired (profile acquisition section) is set based on (R5) “a length of the profile acquisition section” and “an interval between the profile acquisition sections,” for example, as shown in FIG. 56, to a direction perpendicular to the second reference pattern with the second reference pattern being set as a middle point thereof (double lines in FIG. 56). The second reference pattern shown in FIG. 56, as described above in connection with FIG. 14, has been corrected so that the corner part is rounded. Furthermore, instead of the above-described second reference pattern, as shown in FIG. 57, the curves demarcating the shape of the exposed pattern obtained by litho-simulator (solid lines in FIG. 57) can be used.

In the second edge detection process, the profile is formed in the positions (section) corresponding to the above-described profile section in the pattern image to-be-inspected, based on the spacing at which the luminance value is examined in the profile acquisition section of (R5). The spacing is set to an arbitrary value equal to or smaller than the normal pixel spacing, and the length of the profile section is set to an arbitrary length longer than the allowable pattern deformation quantity. The profile is formed by using the bilinear interpolation, the spline interpolation, or Fourier series.

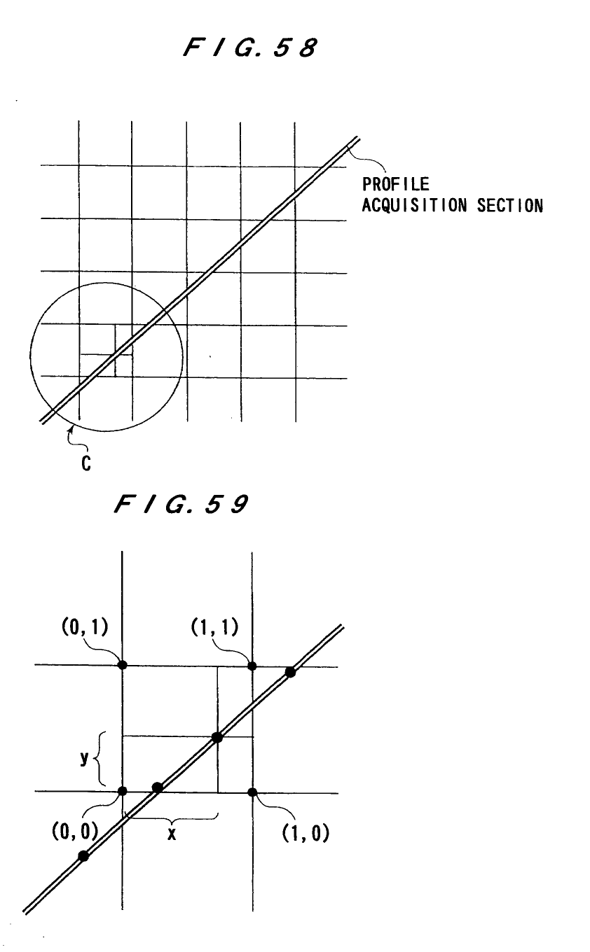

FIG. 58 is an enlarged diagram of a part of FIG. 56 (portion B) and FIG. 59 is an enlarged diagram of a part of FIG. 58 (portion C). The double lines in FIG. 58 indicate the profile acquisition sections, intersections of the grid represent positions of the pixels, and the solid circles show positions where the luminance value of the pattern image to-be-inspected is examined.

The bilinear interpolation method is a method in which the luminance value I(x, y) at a position (x, y) (0<x≦1, 0≦y≦1) is calculated by the following formula using the luminance values I(0,0), I(0,1), I(1,0), I(1,1) of the pixels indicated by (0, 0), (0, 1), (1, 0), (1, 1).

I(x, y)=[I(0,0) (1−x)+I(1,0)x](1−y)+[I(0,1)(1−x)+I(1,1)x]y

From the profile obtained by this formula, the second edge position is determined by applying the threshold value method. As shown in FIG. 60, the maximum luminance value V and its position P in the obtained profile are found. The maximum luminance value V is multiplied by a previously specified coefficient k to find a threshold value T, and intersections of a line whose luminance value is equal to the threshold value T and the profile curve are obtained. An intersection Q of these intersections, which is located in an outward direction of the pattern from the point P and is closest to the point P, is obtained. For all the profiles, such intersections Q are obtained and regarded as the discrete positions of the second edges.

The coefficient k plays a role to determine the second edge positions. That is, since the actual cross-sectional shape of a wiring pattern formed on the wafer has a trapezoidal shape, whether control of the edge position should be conducted at the upper side, the lower side, or the middle part between both sides thereof can be adjusted by the coefficient k.

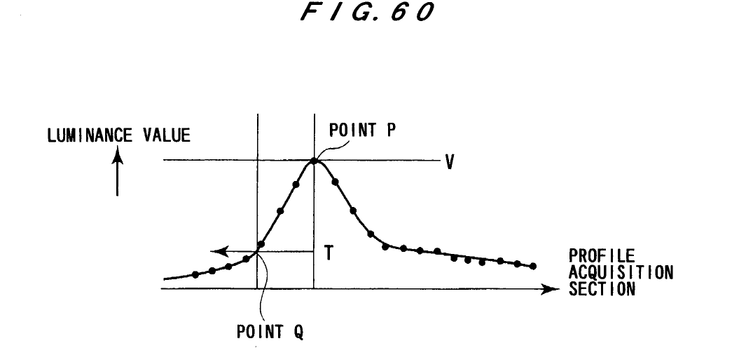

After the above-described edge positions are obtained, those positions are approximated with curves (including the polygon approximation) to define the second edges. The simplest method for this purpose is to link those positions simply with segment lines (polygonal lines). However, as a method to link the positions smoothly using a least-squares method, for example, the following method can be used. That is, as shown in FIG. 61A, the Split-and-merge method disclosed in T. Pavlidis and S. L. Horowitz, “Segmentation of plane curves,” IEEE Trans. on Computers, Vol. C-23, No. 8, August, 1974 can be used. Alternatively, a curve approximation based on smoothing of plane data using the least-squares method and a two-dimensional spline function, as shown in FIG. 61B, can also be used. The former can be processed at a high speed, but has little flexibility for shapes containing a lot of rounded parts. One the other hand, the latter can be processed at a high speed and can be flexible. Besides the above methods, various methods such as a method using a Fourier descriptor have been disclosed and one of these can substitute for the above methods.

Such curve approximation as described above may be conducted after the first edge detection is completed.

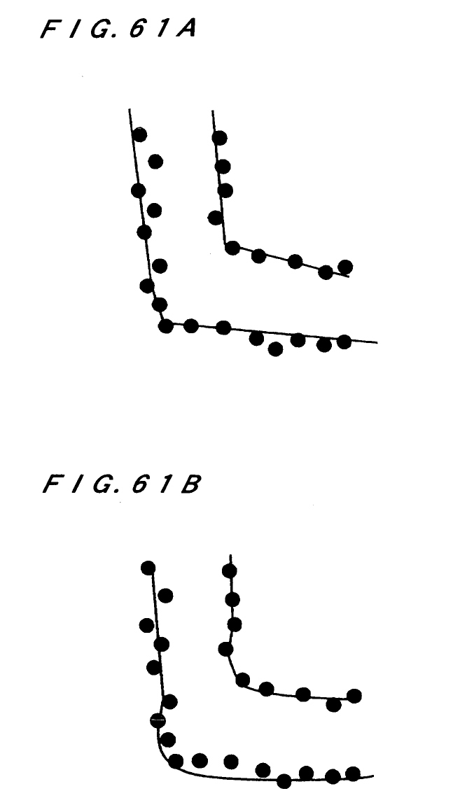

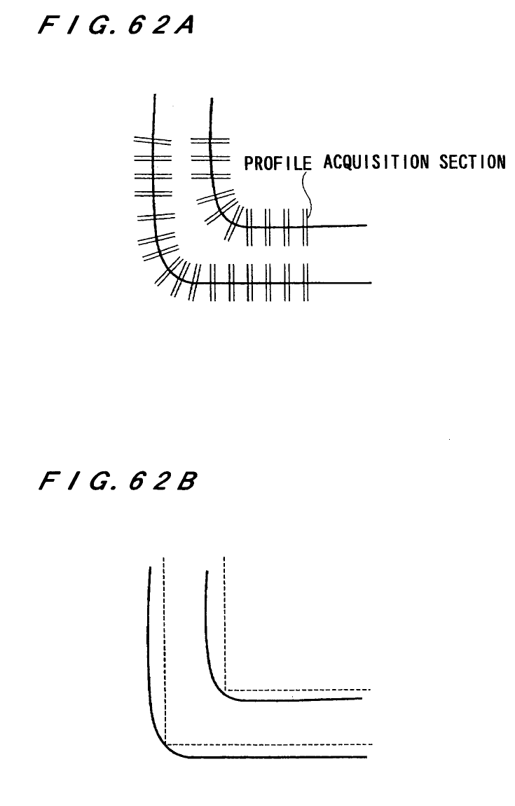

Next, as another method of conducting the approximation which is different from the above, there is a method in which the profile acquisition sections are variable initially and are fixed when detecting the edges. Specifically, as shown in FIG. 62A, in this method, the profile acquisition section is set in a direction perpendicular to the detected first edge of the pattern image to-be-inspected. According to this method, as shown in FIG. 62B, even if the first edges (solid lines) of the pattern image to-be-inspected are displaced from the second reference pattern (dotted lines), the profile acquisition sections can be specified and the edges can be detected. This method can easily follow the deformation of the pattern compared to the above-described method. After the profile acquisition sections are set, the same processing as the aforesaid method is conducted.

A result of the second edge detection can be outputted to the display device 5 and the printer 6.

The detected second edges can be converted into the edge vectors for respective pixels, for example, using the method described in connection with FIG. 19. This edge vector corresponds to the edge vector obtained by the binarization processing before the first inspection.

(The Second Inspection)

After the detection of the second edge as described above, the inspection unit 12 performs the second inspection (step S336).

This inspection is the same processing as the first inspection described above, conducts the defect detection, and obtains the pattern deformation quantity. The displacement quantity (the shift quantity) S₃ concerning the whole image corresponds to the above-described quantity S₂. The obtained quantity S₃ plus the above S₁ and S₂ becomes the total shift quantity between the second reference pattern and the pattern image to-be-inspected.

The inspection result is outputted to the display device 5 and the printer 6 through the output unit 13 (step S338).

When the above processing has been conducted for all the inspection unit areas, the inspection processing is terminated; when the above processing has not been conducted yet, the flow goes back to step S308 (step S340).

(Other Inspection)

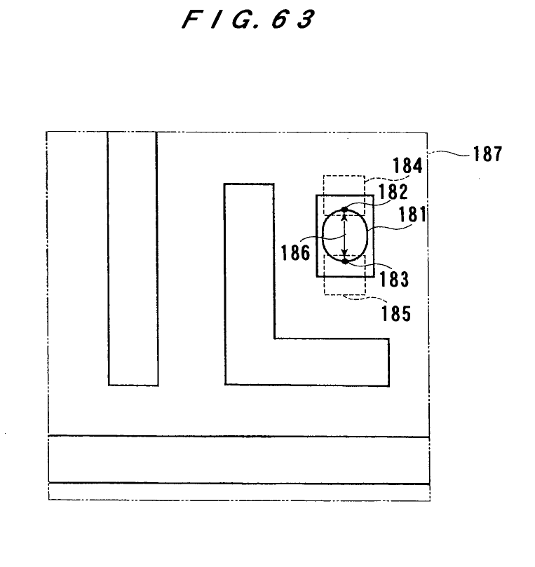

In the case of an SEM with a function that enables a part of a low-magnification image to be observed with a high-magnification electromagnetically, a pattern that cannot be observed in full view with a high-magnification can also be measured. That is, this means that the edge position obtained with a high-magnification can be converted correctly into the edge position obtained with a low-magnification. A similar relation may be realized with a high-precision stage. For example, in FIG. 63, if positions 182 and 183 on a pattern 181 of the pattern image to-be-inspected are obtained using a high-magnification images 184 and 185, respectively, these positions are converted into the positions on a low-magnification image 187, and a width 186 of the pattern 181 of the pattern image to-be-inspected is obtained; the width 186 can be measured more accurately than that as measured only using the low-magnification image 187.

(Adjustment of Inclination and Magnification)

In the foregoing inspection methods, by using a technique for the pattern deformation quantity, adjustment of the inclination and magnification of the pattern image to-be-inspected can be conducted before the inspection or at an appropriate time during the inspection as needed. That is, a part suited to the adjustment of the pattern image to be-inspected and the reference pattern is acquired. Through the affine transformation, several pattern images to-be-inspected that have been subjected to the alteration of the inclination and magnification and can be candidates are obtained. By comparing the obtained pattern images to-be-inspected and the reference pattern, a pattern image to-be-inspected whose pattern deformation quantity is the minimum is selected. The inclination and magnification for the selected pattern image to-be-inspected are registered as the correction quantities. Alternatively, other than affine transforming the pattern image to-be-inspected, a method of affine transforming the reference pattern may be adopted.

Here, the affine transformation means the linear transformation using the coefficients of ‘a’ to ‘f’.

X=ax+by+c

Y=dx+ey+f

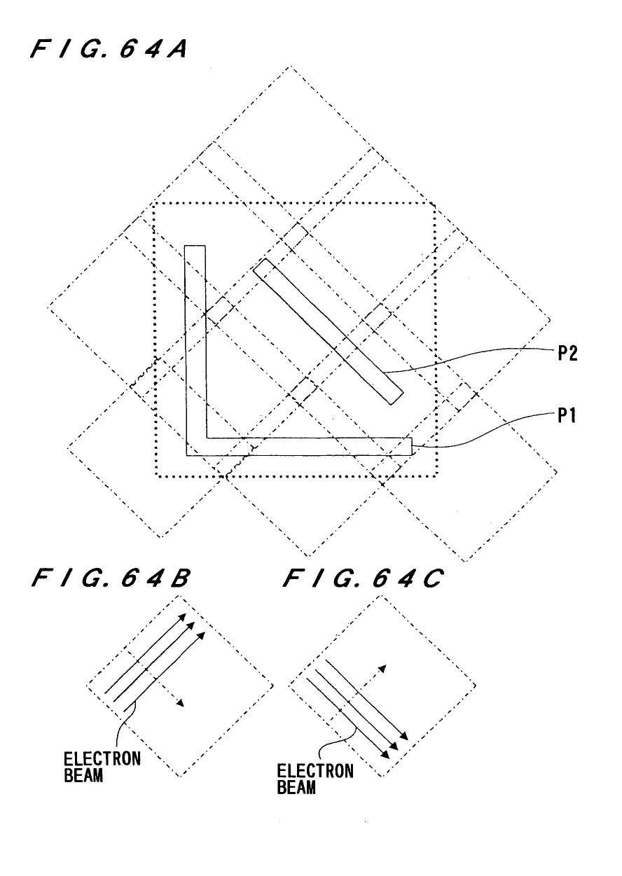

FIGS. 64A, 64B, and 64C schematically show the manner in which a scanning direction for an electron beam is 45 degrees and −45 degrees. FIG. 15 is illustrative of a successive inspecting process, and shows the manner in which a scanning direction for an electron beam is 0 degree and 90 degrees. If the scanning direction is 0 degree and 90 degrees, then it is necessary almost certainly to perform two scans. According to the present process, a pattern P1 made up of only vertical and horizontal lines as shown in FIG. 64A may be scanned once at 45 degrees as shown in FIG. 64B or at −45 degrees as shown in FIG. 64C to achieve desired measuring accuracy for the vertical and horizontal lines. If there is a line P2 at 45 degrees as shown in FIG. 64A, then the patterns need to be scanned twice at 45 degrees and −45 degrees. It is expected that the frequency of requiring only one scan is relatively large compared with the pattern P1 made up of only vertical and horizontal lines.

Details of the scanning direction at 45 degrees or −45 degrees will be described below. In FIG. 64B, the desired measuring accuracy for a pattern that is inclined downwardly to the right is achieved when the pattern is scanned in the direction at 45 degrees. However, the desired measuring accuracy for a pattern that is inclined upwardly to the right cannot be achieved when the pattern is scanned in the direction at 45 degrees because the scanning direction and the direction of the pattern agree with each other. In such a case, an image produced when the pattern is scanned at −45 degrees as shown in FIG. 64C is used, and the results of two scans performed in the scanning directions at 0 degree and 90 degrees are observed to detect any defect on the pattern. It is expected that the frequency of making the scan at −45 degrees is smaller than the scans performed in the scanning directions at 0 degree and 90 degrees.

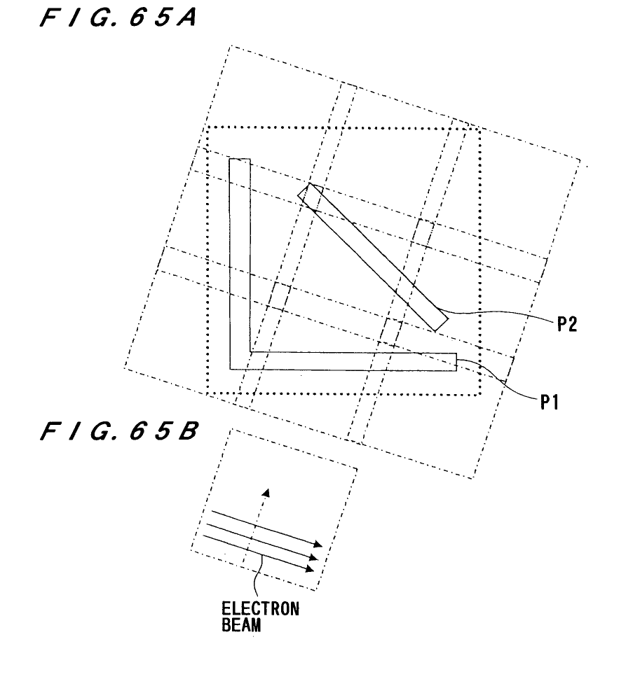

FIGS. 65A and 65B schematically show the manner in which a scanning direction for an electron beam is 18 degrees. FIG. 65A shows patterns P1, P2 which are identical to those shown in FIG. 64A. Patterns such as LSI circuit patterns or the like mostly have vertical lines and horizontal lines or lines inclined downwardly and upwardly to the right at 45 degrees, which make up substantially 99% of all the lines of those patterns. An optimum scanning direction for causing the scanning beam to cross edges to be measured of patterns in all those directions is considered to be a scanning direction at 18 degrees, as shown in FIG. 65B. The scanning direction at 18 degrees is expected to achieve relatively satisfactory measuring accuracy for all pattern lines that are vertical, horizontal, and inclined at 45 degrees.

The scanning direction may be at an angle other than 18 degrees insofar as it extends more perpendicular to all the lines of patterns to-be-inspected. For example, the scanning line may be at 22.5 degrees, 63 degrees which is the sum of 18 degrees and 45 degrees, or 108 degrees which is the sum of 18 degrees and 90 degrees.

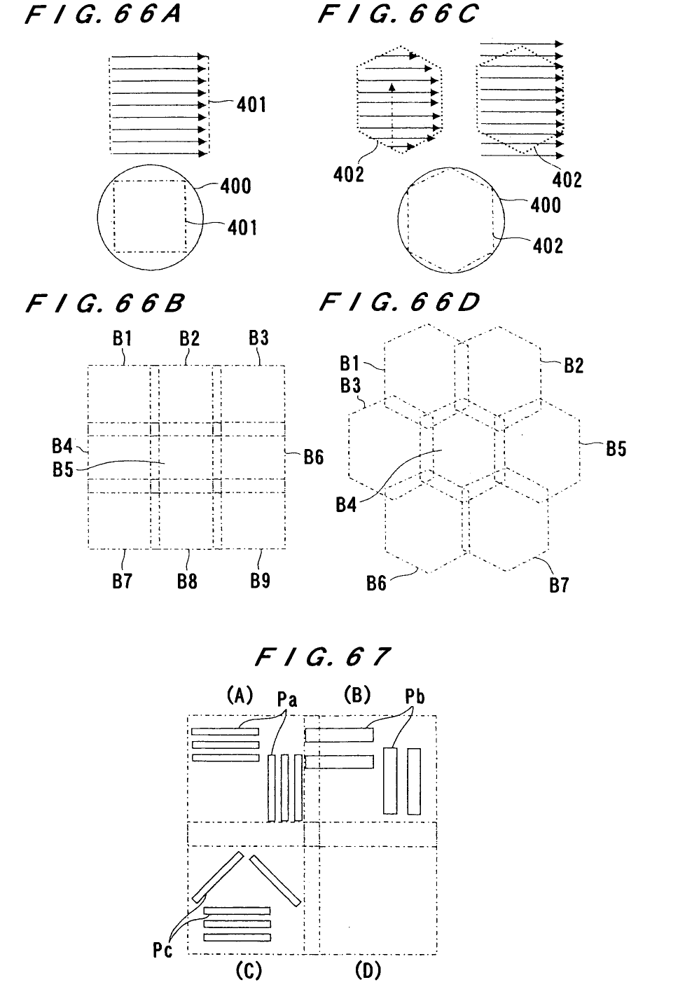

Ordinary scanning electron microscopes such as CD-SEM or the like generally capture a square image with horizontal scanning lines. However, because of control limitations on scanning electron microscopes, an area that can be scanned free of distortions by the scanning electron microscope is a circular area. Therefore, as shown in FIG. 66A, it is customary for a scanning electron microscope to scan a pattern using a square block 401 within a circular block 400. The circular block 400 contains area segments that can be scanned, but are not scanned, vertically and horizontally outside of the square block 401. Accordingly, some area segments are wasted when a larger scanned area is captured. Specifically, when smaller scanned areas are overlappingly combined into a larger scanned area, the larger scanned area may comprise nine overlapping square blocks B1 through B9 as shown in FIG. 66B. If a hexagonal block 402 (see a lower section of FIG. 66C), rather than a square block, is captured by one scan, then an area that approximates a circular area can be captured, using wider area segments that can be scanned than with the square block. The hexagonal block 402 may be scanned in two ways. According to the first process, as shown in a left section of FIG. 66C, the hexagonal block 402 is scanned fully inside, but not outside. According to the second process, as shown in a right section of FIG. 66C, a rectangular area containing the hexagonal block 402 is scanned, and upper right, lower right, upper left, and lower left triangular area segments around the hexagonal block 402 within the rectangular area are not used for measurement. Using such hexagonal blocks makes it possible to capture a wider area with a less number of scans for blocks B1 through B7, than square blocks, as shown in FIG. 66D.

FIG. 67 is illustrative of a process of determining a scanning direction for an electron beam based on a reference pattern.

It is necessary to automatically determine conditions as to whether an area is to be scanned once or twice according to a reference pattern, as with the description of the scanning directions at 0 degree and 90 degrees.

There are available three processes for automatically determining a scanning direction for an electron beam, as described below.

According to the first process, if a pattern to-be-inspected is not present in a scanning area, then patterns in that scanning area are skipped. According to the second process, scanning conditions are determined depending on the line width of a pattern. For example, a comparison between patterns Pa in a block (A) and patterns Pb in a block (B) indicates that the line width of the patterns Pb is twice the line width of the patterns Pa. Since a scan normally takes a variation commensurate with the line width of a pattern, an image can be acquired by a scan in the block (B) at a magnification of ½ with respect to a scan in the block (A). According to the third process, conditions for a scanning direction are determined depending on the direction of a distribution of reference patterns. For example, since patterns Pa are distributed vertically and horizontally in the block (A), it can be seen that the block (A) may be scanned once in a scanning direction at 45 degrees, and since patterns Pc are distributed horizontally and at 45 degrees in a block (C), it can be seen that the block (C) may need to be scanned twice.

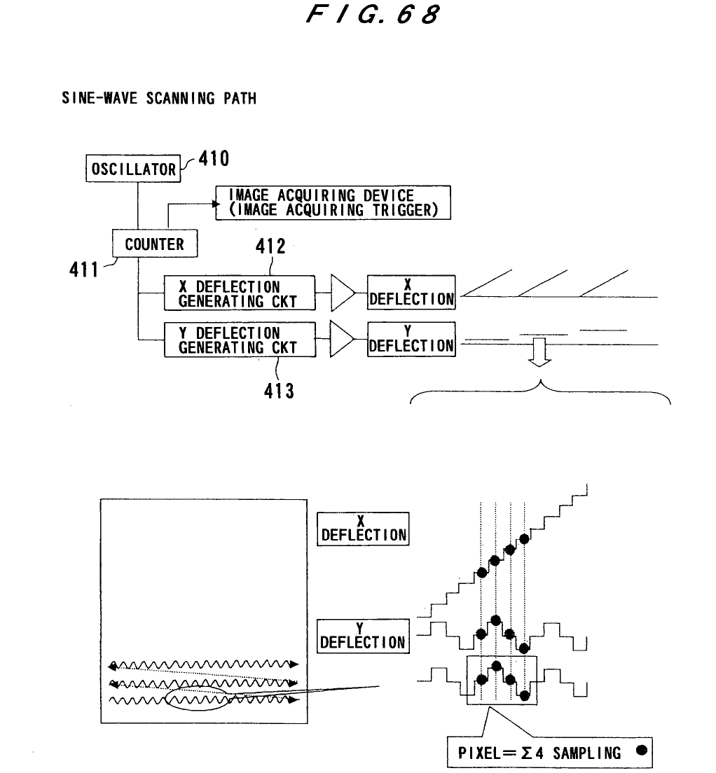

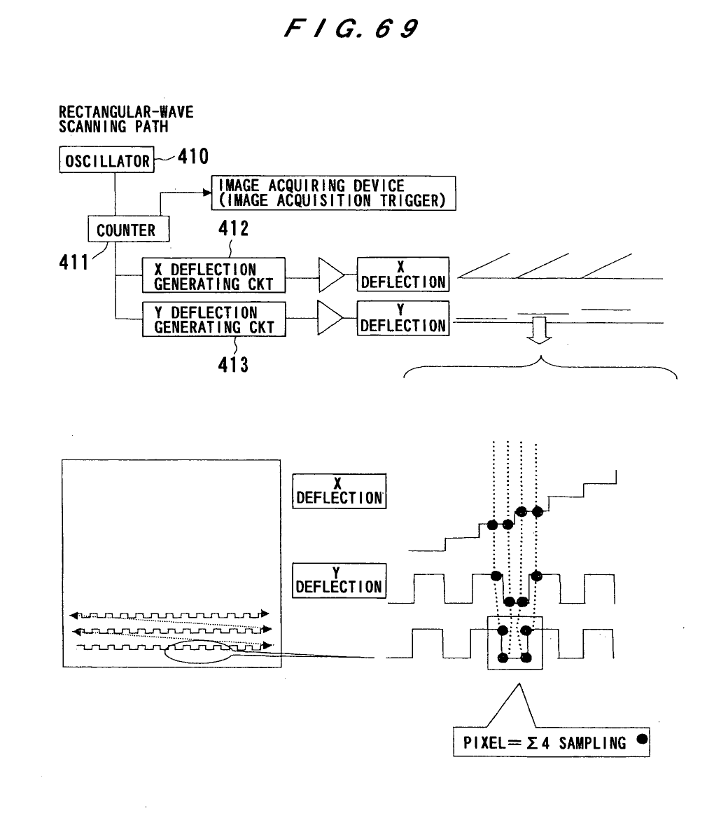

FIGS. 68 and 69 show scanning paths for an electron beam.

In ordinary scans, a pattern is scanned stepwise for the deflection in the X direction and scanned stepwise in each line for the deflection in the Y direction. According to such a conventional scanning process, the measuring accuracy is liable to be low because no information can be acquired between scanning lines. According to the present invention, as shown in FIG. 68, in order to acquire information between scanning lines, a signal having an amplitude, such as a sine-wave signal, is added for the deflection in the Y direction for acquiring data between the scanning lines (see a lower left section of FIG. 68). As shown in FIG. 68, data at four points are sampled (see a lower right section of FIG. 68). In this manner, spread data for the deflection in the Y direction can be acquired in one period of the sine wave. The data from the four points are added and transmitted as one-pixel information to a computer.

As shown in an upper section of FIG. 68, an oscillator 410 having a frequency which is four times the sampling frequency of the scanning process is connected to a counter 411. The counter 411 is connected to an X-deflection generating circuit 412 and a Y-deflection generating circuit 413. The circuit arrangement thus constructed generates a stepwise waveform that increases to the right for the deflection in the X direction, and a waveform as shown, such as a sine wave, for the deflection in the Y direction, based on the clock signal whose frequency is four times the sampling frequency of the scanning process. Data at the four points are sampled at a fourfold period, and added into sampling data corresponding to an actual pixel.

In FIG. 69, a waveform, as shown, for the deflection in the Y direction and a waveform for the deflection in the X direction are generated using a fourfold clock counter for thereby producing a zigzag scanning path.

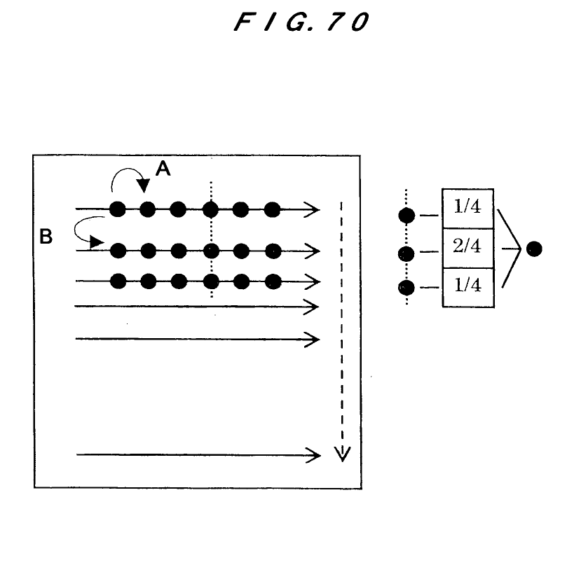

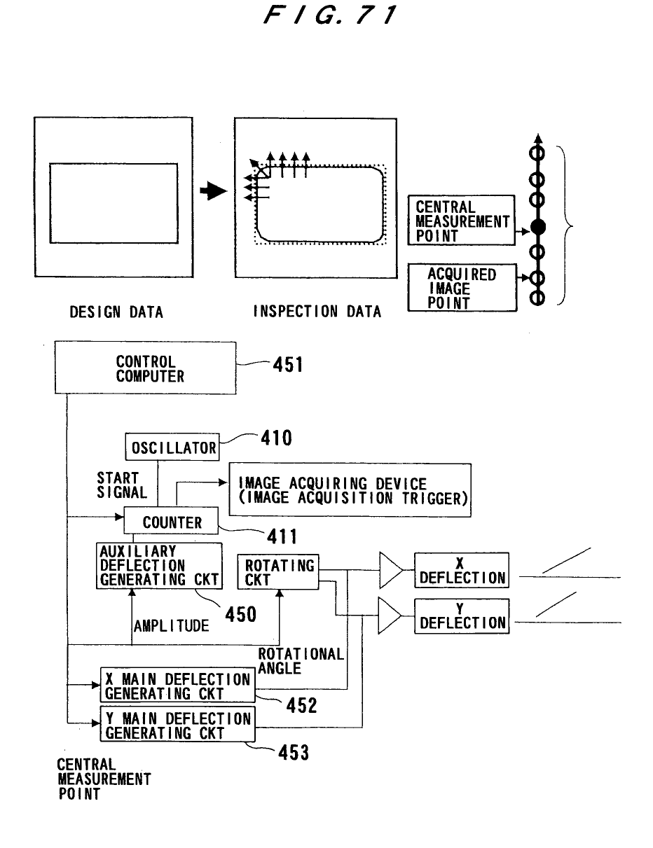

FIG. 70 schematically shows the filtering of a vertical scan. Pixels A are close to each other in the horizontal direction and are subject to a smoothing effect by a detector and an amplifier. Pixels B are close to each other in the vertical direction, but are not subject to a smoothing effect. Therefore, a smoothing filter is applied vertically to reduce the difference between image qualities in the vertical and horizontal directions. In FIG. 70, simplest filtering coefficients are illustrated. However, optimum filtering coefficients may be selected to match horizontal frequency characteristics.

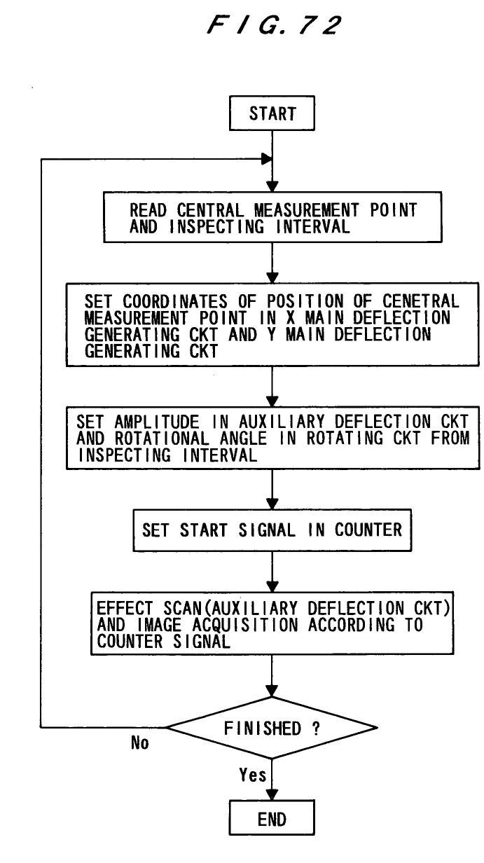

FIG. 71 schematically shows the manner in which only an edge is scanned, and FIG. 72 is a flowchart of the steps of a process of scanning an edge. The circuit arrangement shown in FIG. 71 includes an auxiliary deflection generating circuit 450.

In a process of scanning only an edge, an interval corresponding to a profile used to detect the second edge mentioned above is registered as a pattern edge inspecting interval and a middle point of that interval is registered as a central measurement point. A control computer 451 reads information as to a single inspecting interval, and sends the position of the central measurement point thereof to an X main deflection generating circuit 452 and a Y main deflection generating circuit 453, for thereby moving the actual central position of the beam. Then, a direction and a feed width for the inspecting interval are set, and a start signal is given to cause a counter 411 connected to an oscillator 410 to generate a scanning waveform in the X and Y directions. The positions for the main deflection in the X direction and the main deflection in the Y direction are added to the generated scanning waveform to produce a scanning waveform shown in a central section of FIG. 71. The scanning waveform is then sampled at seven points as shown in an upper right section of FIG. 71 to obtain measured data.

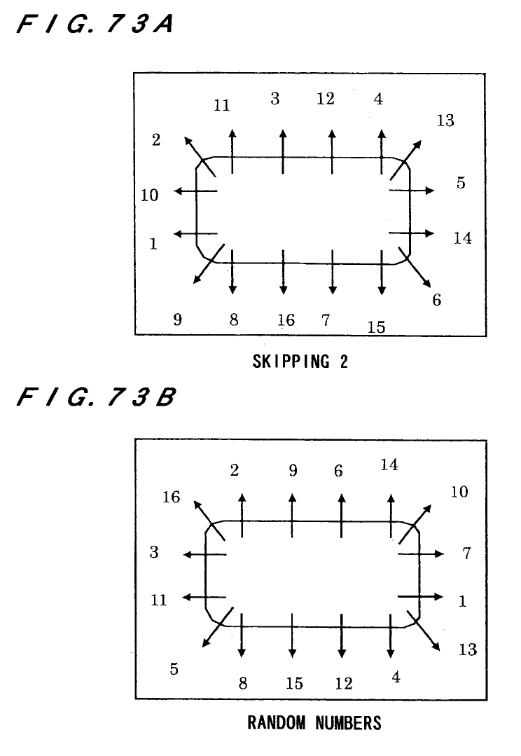

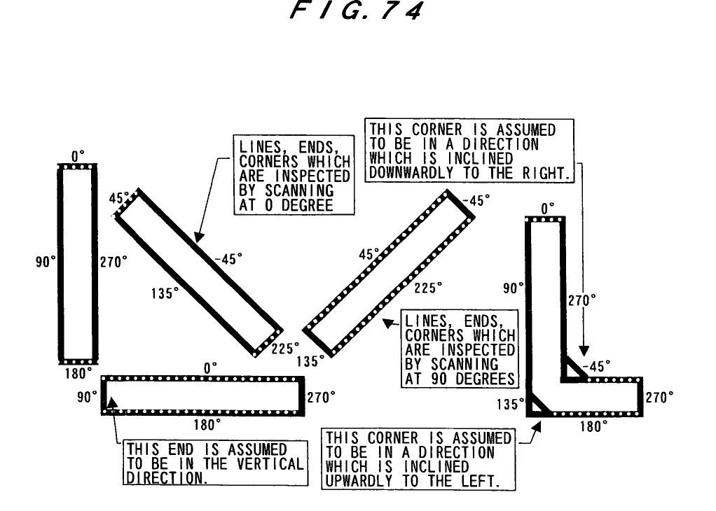

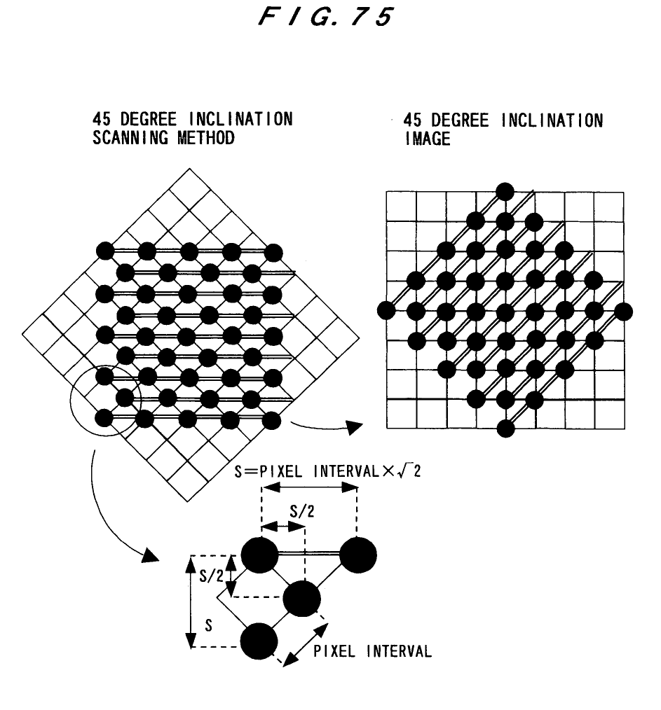

The acquisition of the measured data may be sequenced by skipping measured points according to a skipping rate as shown in FIG. 73A until all measured points are covered, or randomly picking up measured points according to random numbers as shown in FIG. 73B. These sequencing processes are effective in reducing a deformation of the profile due to a charge-up effect of the sample, and hence are suitable for measuring insulated objects. If a charge-up effect of the sample can be ignored, then the acquisition of the measured data may be sequenced so as to make a full round of the pattern of the measured points.

Through the use of the information that can be obtained by the aforesaid inspection method of the present invention, such as the pattern deformation quantity, and the position, size, and defect class of the defective area, plus the statistic quantity of the pattern deformation quantity and the images, the following can be performed: an analysis of influence of the defective area on the circuit; an analysis of influence of the previous/subsequent process on the circuit; and an analysis of the optimized parameters such as an exposure condition.

If attention is given to a part for outputting the shift quantity, the pattern inspection apparatus according to this embodiment can also be considered as an apparatus for performing the pattern matching.

While embodiments of the present invention have been described above, various changes or modifications may be made therein. For example, while a scanning electron microscope is employed in the embodiments as an image generator for scanning a pattern to-be-inspected with a charged particle beam (electron beam) to obtain an image of the pattern to-be-inspected, the present invention is also applicable to any of various other scanning microscopes including a scanning focus ion beam microscope, a scanning laser microscope, and a scanning probe microscope. The scanning directions are not limited to those at 0 degree and 90 degrees, but may be those with desired small angles added, e.g., 5 degrees and 95 degrees.

For example, it is easy to modify this embodiment into an off-line input processing system in which the acquired image data is inputted through an external input device such as the magneto-optical disk and the magnetic tape or through an LAN such as the Ethernet. Moreover, it is possible to construct a hybrid technique in which a typical die in the wafer is inspected by the method according to the present invention and other dies are inspected by the die-to-die comparison. Furthermore, the image generation method may be any method other than the method described in this embodiment, and the design data is not limited to the CAD data, but may be other type of data. In this embodiment, the inspection result and the like is outputted to the display device 5 and the printer 6, but may be outputted to an image database, a simulator, a recording medium, etc., or may be transmitted (outputted) to other computer through a network.

As described above, the present invention offers the following advantages:

(1) In order to obtain an image of a pattern to-be-inspected, the pattern may be scanned with a minimum electron beam (charged particle beam), and hence image of the pattern to-be-inspected can be obtained in a minimum period of time.

(2) An area that can be scanned is utilized at maximum, thus allowing a wider block to be represented by as few smaller blocks as possible, and a reduction in the accuracy to detect an edge which depends on the scanning direction can be acquired according to an optimum process using a reference pattern.

(3) The difference between the image qualities in the X and Y directions can be reduced to the utmost by a process of changing the waveform of data-lacking portions of a raster scan, making scans twice, or filtering.

(4) A deformation of a profile due to a charge-up effect of the sample can be reduced, thus increasing the accuracy of a deformation quantity of the pattern. An image can be acquired at a high speed by scanning only an edge which is most important for measurement, rather than making a raster scan over the entire pattern to acquire data.

(5) The rotated image can be acquired without lowering of image quality due to interpolation, and hence the detection accuracy of the edge can be prevented from being lowered.

Although certain preferred embodiments of the present invention have been shown and described in detail, it should be understood that various changes and modifications may be made therein without departing from the scope of the appended claims.

What is claimed is:

1. A pattern inspection apparatus for inspecting a pattern to-be-inspected by comparing the pattern to-be-inspected with a reference pattern, comprising:
a storage device for storing said reference pattern;
an image generator for scanning the pattern to-be-inspected with a charged particle beam to produce an image of the pattern to-be-inspected;
an input device for inputting the image of the pattern to-be-inspected;
an inspection device for inspecting the pattern to be-inspected by comparing an edge of the inputted image of the pattern to-be-inspected and an edge of the stored reference pattern with each other; and
an output device for outputting a result of the inspection of the pattern to-be-inspected;
wherein said image generator sets a scanning direction for the charged particle beam based on said reference pattern.

2. A pattern inspection apparatus according to claim 1, wherein said scanning direction for the charged particle beam is determined so as to be more perpendicular to all patterns to-be-inspected.

3. A pattern inspection apparatus according to claim 2, wherein said scanning direction for the charged particle beam comprises a scanning direction which is ±90 degrees with respect to the direction which is determined so as to be more perpendicular to said patterns to-be-inspected.

4. A pattern inspection apparatus according to claim 1, wherein said scanning direction for the charged particle beam is determined so as to be more perpendicular to most frequent directions of patterns to-be-inspected.

5. A pattern inspection apparatus according to claim 4, wherein said scanning direction for the charged particle beam comprises a scanning direction which is ±90 degrees with respect to the direction which is determined so as to be more perpendicular to said patterns to-be-inspected.

6. A pattern inspection apparatus according to claim 1, wherein rotated image is acquired by replacing the position of pixels.

7. An image generating apparatus for generating an image of a pattern to-be-inspected by scanning the pattern to-be-inspected with a charged particle beam, comprising:
means for scanning a given area of the pattern to-be-inspected to generate a hexagonal image thereof;
means for scanning an area, adjacent to said given area, of the pattern to-be-inspected to generate a next hexagonal image thereof; and
means for repeatedly scanning successive areas of the pattern to-be-inspected to generate a single image of a wide area of the pattern to-be-inspected.

8. A pattern inspection apparatus for inspecting a pattern to-be-inspected by comparing the pattern to-be-inspected with a reference pattern, comprising:
a storage device for storing said reference pattern;
an image generator for scanning the pattern to-be-inspected with a charged particle beam to produce an image of the pattern to-be-inspected;
an input device for inputting the image of the pattern to-be-inspected;
an inspection device for inspecting the pattern to be-inspected by comparing an edge of the inputted image of the pattern to-be-inspected and an edge of the stored reference pattern with each other; and
an output device for outputting a result of the inspection of the pattern to-be-inspected;
wherein said image generator scans a wider area of the pattern to-be-inspected by imparting a vertical amplitude to a scanning direction for the charged particle beam.

9. A pattern inspection apparatus for inspecting a pattern to-be-inspected by comparing the pattern to-be-inspected with a reference pattern, comprising:
a storage device for storing said reference pattern;
an image generator for scanning the pattern to-be-inspected with a charged particle beam to produce an image of the pattern to-be-inspected;
an input device for inputting the image of the pattern to-be-inspected;
an inspection device for inspecting the pattern to be-inspected by comparing an edge of the inputted image of the pattern to-be-inspected and an edge of the stored reference pattern with each other; and
an output device for outputting a result of the inspection of the pattern to-be-inspected;
wherein said image generator scans only a pattern portion to-be-inspected to determine a deformation quantity of the pattern.

10. A pattern inspection apparatus according to claim 9, wherein said image generator scans only the pattern portion to-be-inspected to reduce a deformation of a profile due to a charge-up effect of the sample.

11. A pattern inspection method for inspecting a pattern to-be-inspected by comparing the pattern to-be-inspected with a reference pattern, comprising:
storing said reference pattern;
scanning the pattern to-be-inspected with a charged particle beam to produce an image of the pattern to-be-inspected, a scanning direction for the charged particle beam being set based on said reference pattern;
inspecting the pattern to-be-inspected by comparing an edge of the produced image of the pattern to-be-inspected and an edge of the stored reference pattern with each other; and
outputting a result of the inspection of the pattern to-be-inspected.

12. A pattern inspection method for inspecting a pattern to-be-inspected by comparing the pattern to-be-inspected with a reference pattern, comprising:
storing said reference pattern;
scanning the pattern to-be-inspected with a charged particle beam to produce an image of the pattern to-be-inspected, a wider area of the pattern to-be-inspected being scanned by imparting a vertical amplitude to a scanning direction for the charged particle beam by said scanning;
inspecting the pattern to-be-inspected by comparing an edge of the produced image of the pattern to-be-inspected and an edge of the stored reference pattern with each other; and
outputting a result of the inspection of the pattern to-be-inspected.

13. A pattern inspection method for inspecting a pattern to-be-inspected by comparing the pattern to-be-inspected with a reference pattern, comprising:
storing said reference pattern;
scanning the pattern to-be-inspected with a charged particle beam to produce an image of the pattern to-be-inspected, only a pattern portion to-be-inspected being scanned to determine a deformation quantity of the pattern by said scanning;
inspecting the pattern to-be-inspected by comparing an edge of the produced image of the pattern to-be-inspected and an edge of the stored reference pattern with each other; and
outputting a result of the inspection of the pattern to-be-inspected.
